(19) United States
(12) Patent Application Publication
(10) Pub. No.: US 2013/0030945 A1
(43) Pub. Date: Jan. 31, 2013

(54) Method for Gifting Via Online Stores

(71) Applicant: B. Robert Polt, Redmond, WA (US)

(72) Inventor: B. Robert Polt, Redmond, WA (US)

(21) Appl. No.: 13/427,006

(22) Filed: Mar. 22, 2012

Related U.S. Application Data
(60) Provisional application No. 61/572,917, filed on Jul. 25, 2011.

(51) Int. Cl. G06Q 30/06; G06Q 20/40; G06Q 20/12

(52) U.S. Cl. 705/26.5; 705/26.81

(57) ABSTRACT

Methods, systems, and associated software for facilitating gifting via online transactions. A method for buying and delivering a gift from an online store is divided into three distinct processes. First, a gift giver selects one or more gift items from the online store and purchases a gift certificate including gift redeeming information used for redeeming the gift item(s). Second, the gift giver transfers the gift redeeming information to a gift recipient of choice. Third, the gift recipient redeems the gift items based on the gift redeeming information received. The gift recipient also is enabled to provide delivery information during the redemption processes, thereby ensuring the redeemed gift(s) is/are delivered to a correct and preferred location. Meanwhile, the gift giver does not need to know the gift recipient's exact delivery information.

### CROSS-REFERENCE TO RELATED APPLICATIONS

This application claims the benefit of the filing date of U.S. Provisional Application No. 61/572,917, filed Jul. 25, 2011, entitled “METHOD FOR PURCHASING GIFTS FROM ONLINE STORES” under 35 U.S.C. §119(e). U.S. Provisional Application No. 61/572,917 is further incorporated herein in its entirety for all purposes.

### FIELD OF THE INVENTION

The field of invention relates generally to online transactions and, more specifically but not exclusively relates to facilitating giving of gifts via online transactions.

### BACKGROUND INFORMATION

Part of a long time tradition, gifts are given for a variety of holidays and special occasions. They are an expression of our appreciation and gratitude towards friends, family, or people we work or otherwise interact with. While gift giving is meant to be an enjoyable and rewarding experience for both the gift giver and the gift recipient, sometimes finding the right present can be a daunting enterprise. Typically, the gift giver has to travel from retail store to retail store and browse through tens or maybe hundreds of articles before choosing the ‘perfect’ gift.

With the advent of modern internet technology, the number of online stores has exploded. These stores offer the alternative solution of shopping conveniently from any location, 24 hours a day, by browsing electronic catalogues on a personal computer or mobile device. This powerful tool has the potential to relieve many of the inconveniences usually associated with gift giving.

Online stores operate one or more online web sites (also referred to as electronic storefronts or e-commerce sites) accessed via the Internet and the World-Wide Web via web browser. The web sites host various web pages via which an online store is enabled to showcase their goods, accept payments, and collect delivery information. Even though online shopping has added the convenience of shopping from home or other places where an internet connection is available, and may offer a wider selection and/or better prices, buying gifts online is still not a very convenient experience.

Gift purchases are an important part of the overall retail market. This includes the purchase of physical gifts at a retail or online store, as well as the purchases of gift cards in both physical and electronic form. Although gift cards are convenient for the gift giver, and provide some level of flexibility for the gift recipient, they are not very personal. Considering the old adage, “it's the thought that counts,” a gift card doesn't convey much thought as it is purely a decision on what amount is appropriate and how much one is willing to spend. In contrast, giving a physical or electronic gift (such as games, software, music or video content, etc.), particularly chosen by the gift giver for the gift recipient, conveys much more than a gift card. A physical or electronic object is something the gift recipient may relate to the gift giver over time, while the connection between an item purchased using a gift card and the gift card giver is more likely to be forgotten.

Using existing e-commerce methods, the most straightforward way to purchase a gift and convey the gift to a recipient is to order the gift in advance as a regular purchase, have it shipped to the purchaser and then physically convey it to the recipient (e.g., handing it to the recipient) at an appropriate time (such as on a recipient's birthday, at a wedding, etc.). This implies planning well ahead to allow enough time for the item to be shipped and delivered to the purchaser prior to when the conveyance is to occur. Even for the most organized individuals, such advanced planning may not work on all occasions and one may have to scramble to the store for a last minute gift purchase. In addition, once received, a gift ordered using this method is difficult to exchange.

Since many shopping cart/checkout schemes on online store web sites allow a purchase to be shipped to a different shipping address than the purchaser's billing address, another method to convey a gift is to buy one or more gift items online as a regular purchase and have the item(s) shipped directly to the gift recipient's home address. In this case the gift giver needs to accurately input the shipping information to ensure it is shipped to the correct address. Entry of an errant address may either cause the item to be shipped to the wrong address, or cause a delay if it is determined by either the store or the shipper that the entered address does not actually exist. It also is often advisable to inform the gift recipient that a gift is being sent in order to coordinate receipt of the delivery. For example, the recipient may be out of town, and would not be available to receive a shipment that might be left on the recipient's doorstep and possibly at risk of being stolen. Also, delivery of a suspect package (that actually contains a gift that is not expected to be received) may even be refused by the recipient.

There are various existing techniques that may be used to facilitate giving gifts through use of online transactions. For example, U.S. Pat. No. 7,222,087 (Bezos et al., Amazon.com Inc.) teaches that the gift giver needs to provide some sort of gift recipient identifying information, preferably a name and an email or street address. Using this information the store will attempt to contact the gift recipient to obtain or confirm shipping information. If contacting the gift recipient is not successful, the store will search various databases to obtain additional contact information. The store will attempt again to contact the gift recipient based on the new information. If contact is successful and shipping address is found, the gift is shipped. If the contact is still not made, the store notifies the gift giver that the gift could not be delivered and places the gift on hold. Additional details relating to implementing the foregoing are disclosed in US 2002/0178089 A1.

In U.S. Pat. No. 6,321,211, Dodd teaches exchanges that can be done before the gift item is shipped, thus avoiding having to mail the gift back if the gift recipient wants to exchange the gift for another item. The gift giver has to enter information about the gift recipient, which typically includes the recipient's name and information to facilitate contact like email address, telephone number or street address. The gift recipient is notified of the gift before the order is placed. In U.S. Pat. No. 6,633,849, Dodd adds forwarding a gift to the method of gift exchanges disclosed in the '211 patent. In this case, after the gift giver provides contact information about the gift recipient and the gift notification is sent, the gift recipient needs to input contact information about the second gift recipient to whom the gift is forwarded.

U.S. Pat. No. 7,831,439 recognizes that providing a flexible method for exchanging online gifts can encourage buyers to a larger selection of gift articles, including some more unexpected ones ‘that the recipient might truly enjoy’ but may carry a higher risk of not being needed, if they can later be easily exchanged. The patent describes a system of implementing a set of customizable rules and databases to assist with gift exchanges.

In U.S. Pat. No. 6,594,644 (also see U.S. Pat. No. 6,175,823), Van Dusen teaches about online monetary value gift certificates and employing hyperlink-based redemption instead of using a claim code. Purchasing gift certificates require at least the name of the purchaser, the name and e-mail address of the intended recipient, and the monetary amount of the gift certificate. Instead of providing a claim code, the email containing the gift certificate includes a hyperlink via which the gift certificate may be accessed. When the hyperlink is selected, the recipient's computer sends a claim code to the merchant's web site, which then credits the recipient's personal account with the gift certificate account. The balance is then automatically applied to future purchases.

U.S. Pat. No. 7,275,041 discloses an e-commerce system by which a first user configures and stores a purchase order and sends an email message to a recipient, the message identifying the stored order and allowing the recipient to purchase it. In some situations this can still be seen as a gift if, for example, the first user is the gift recipient configuring its own gift and the recipient of the e-mail message completes the purchase order by making payment for it.

A common drawback of these methods is that they all require the gift giver to input some form of contact information associated with the gift recipient, such as the recipient's shipping address or email address, which the store will need to use to initiate contact and to obtain or confirm the shipping information. In many cases this information may not be readily available, requiring the gift giver to check his/or her contact information, address book, etc., or contacting someone else who might have the information. In most cases it is much easier to enter his/her own physical (street) address or electronic email than somebody else's data, even in the case of friends or family members. Even if, for example, one may know how to drive to somebody's home, that person can have difficulties reciting the exact address. This also applies to email addresses. It is easier to reply to a message or retrieve the email address from the contacts list than actually input it correctly from memory. Finding an email address while performing an online checkout process typically requires the user to perform additional actions, such as opening an email application, checking the email address, and copy it to the applicable input box on the checkout page. Having to scramble to find the correct information can prove inconvenient for the gift giver, especially for a last minute gift purchases, also known as distress purchases. Problems may also arise when filling out unfamiliar data, such as inputting inaccurate recipient email address or using the wrong address. The email address may no longer be valid, or the account could be neglected or checked only rarely. Confusion can also occur when, for example, similar names exist in the gift giver's Contacts database.

Some credit card companies may require that the credit card is not charged before the article is shipped (or otherwise this may be the online retailer's internal practice). In most of the gift giving methods above, shipping is delayed by the need to check and, if needed, to make corrections to the shipping address input by the gift giver or to obtain the shipping address by contacting the gift recipient. During this time the store has to hold the gift item available while at the same time it is not able to immediately receive cash for the purchase, which results in a prolonged cash conversion cycle and increased inventories. The delay time may vary largely depending on the responsiveness of the gift recipient and gift giver and the accuracy of the input data.

An alternative is to use a monetary value gift certificate available, for example, from online stores like GiftCertificates.com. Even though this is more diversified as it enables choosing an online store with a certain profile, such gift certificates have similar disadvantages when compared with gift cards as they ostensibly attach a currency value to the gift. Another consideration is that, in general, the recipient of a monetary gift certificate or gift card may have to spend some of his or her own money when the certificate is redeemed, since it is unlikely that any item or items purchased using the gift certificate or card will have the exact same value as the certificate or card.

### SUMMARY OF THE INVENTION

In accordance with aspects of the present invention, methods, systems, and associated software is provided for facilitating gifting and related transactions that overcome many of the shortcoming of existing methods relating to buying and delivery of gifts via online transactions. In accordance with one aspect, a method for buying and delivering a gift from an online store is divided into three distinct processes: First, the gift giver selects the gift items and orders gift redeeming information; second—the gift giver transmits the gift redeeming information to the gift recipient of choice; and third—the gift recipient redeems the gift items based on the information received. The direct contact with the gift recipient initiated by the gift giver provides the link between two virtually separate store processes: the purchase and the redeeming of the gift. According to the method, the critical gift recipient contact and shipping information is input by the person who has the most knowledge of the information, the gift recipient, during the gift redeeming process.

During the first process, the gift giver selects one or more gift items from the store catalog and makes the purchase by entering payment information including the billing address as required for payment authorization. There is no specific need for a gift specific store catalogue—gift items may be selected from the regular store catalog. Once the selection is done, the online store produces a gift certificate including a Unique and Secure Number (USN) that may be used to redeem the selected gift item(s). The gift giver has the option to enter his/her contact information, such as email and/or street address, thereby designating how and where a gift certificate containing the USN may be sent. The gift certificate can be delivered by electronic mail, regular mail, via SMS to a mobile device, or any other physical or electronic means. Alternatively, the store can create a web page containing the gift certificate information, which can be accessed during the shopping session in which case the gift giver's own contact information would not be needed. In general, the gift certificate or the information transmitted to the gift recipient will include the USN or other unique indicia, as well as information for accessing the redeeming site, such as redeeming site URL. Other optional information may be entered during the gift purchase phase, such as a message from the gift giver, the gift giver's name, the gift recipient name, time the article will be on hold for redeeming, date of purchase, description of the gift item, etc.

If one of the delivery methods fails, there are fallback techniques for the gift certificate or redeeming information to be resent. This may involve the existence or creation of a customer account with a customer ID and password, where the gift item can be retrieved, or customer service can be called.

In order to calculate the total purchase costs, applicable or estimated shipping charges and tax amounts are determined. Taxes are usually calculated according to state or interstate regulations. Such regulations can stipulate, for example, that, the tax at purchase is calculated based on the gift giver's billing or shipping address. In case the gift certificate is sent electronically and the shipping address is not entered, the billing address can be used. Also, a box can be checked if the shipping address is the same as the billing address.

Estimation of Shipping and Handling fees relating to one or more gift items associated with a gift certificate may be calculated without having to input the actual shipping address. Generally, S&H fees may be based on one or more delivery methods and destinations (such as delivery zones used by various shippers), a fixed fee, or no fee at all. This can be an average charge, the minimum charge, or a charge determined in some other way. In another embodiment the gift giver may be asked to select the most probable shipping area from a list of different fee areas provided by the store or the carrier. A delivery method such as ‘Ground’ or ‘2^{nd}-day delivery,’ may be selected. Alternatively, if the online store also has a physical presence, an item may be designated for in store pickup through selection of an ‘In store’ delivery method. In case the delivery area is not known, a default rate may be estimated and/or charged, such as, for example, a maximum ground delivery rate based on the size and/or weight of the shipping box. Since the package weight and size is usually available from a store catalog or other database, this information may be readily used in such a calculation. If it turns out that the S&H fee is higher than initially estimated, the store can require either the gift giver or the gift recipient to cover the difference. To avoid this, a fixed general rate or, optionally, a local rate may be calculated and paid for during the purchase. If changing the delivery method is allowed and the gift recipient opts, for example, for a faster delivery, he/she will be required to cover the difference. While the handling part of the fee should not vary, there are many considerations that can dictate the shipping charge policy. The actual method and conditions of handling Shipping & Handling costs can be stipulated in the Terms & Conditions agreement.

At the completion of the first process, the gift purchase transaction between the gift giver and the store is completed. The gift giver has made a payment for the gift and the store has sent a product in the form of a gift certificate that entitles a recipient to the gift item(s). It is now the gift giver's responsibility to transmit the gift certificate to the gift recipient and then the gift recipient's responsibility to redeem the gift item by supplying his or her shipping information. The conditions of the transaction can be stipulated in the Terms and Conditions agreement that acknowledges the delivery of the gift certificate to the gift giver and the transfer of funds for the payment.

The second process takes place outside the store between the gift giver and the gift recipient. Here, the gift giver transmits the gift certificate information to the gift recipient. This can be done in person in the form of handing out a hard copy of the gift certificate, or electronically by forwarding an email with the gift certificate information received from the store. Away from the pressure of an online purchasing session (and its associated potential for crashes and/or disconnections), the gift giver has the time to search for the gift recipient's email and/or street address. If necessary, another person or even the gift recipient himself can be called and asked. If email was used to notify the gift recipient of the gift and to forward the gift certificate and there were problems delivering the email, for example, due to an out-of-date email address, the gift giver will usually be notified, for example, by a message such as “email address not found”. The gift giver can rapidly take corrective action and try other means of contacting the gift recipient. By potentially knowing other people from the gift giver entourage and having alternative ways for contact, the gift giver is in a much better position than the store to find the right way to deliver the gift information.

The third process takes place between the gift recipient and the store. The gift recipient accesses a web page provided on the gift certificate for redeeming the gift and provides delivery information. Entering this information can be done in different ways. For physical gifts a shipping address is needed. For electronic gifts an email is supplied if email is used for delivery, or the browser's ‘Save’ or ‘Install’ application can be guided to a storage or installation location, respectively, which could even be a default or last used location, on a personal computer or other storage media.

By entering the USN, the gift item(s) is retrieved from the store order database. During the prior purchase process, the store system tags each gift item that is purchased as a “purchased gift,” and places the item on hold for a specified period of time. Since the gift amount has already been paid when the gift certificate is delivered, having the money available, for example, to replenish the inventory, may, by itself, cover storage costs for the holding period. If the holding time expires then the item is no longer on hold but it can still be redeemed or exchanged for another item as a regular store item.

Some existing gift systems have separate databases designated for gift items. With the new process, there is no need for the store to identify an item specifically as a gift or, for that matter, to use a different store catalogue. The buyer can chose any item from the regular catalog as a gift item. Nevertheless, the store can, at its own discretion and for whatever reasons it finds necessary, prohibit certain items from being purchased as gifts. This allows the regular store selection to be used for gift certificate purchases. Even though elements would have to be added to assist both the gift giver's purchasing session and the gift recipient redeeming session, the main functions of the shopping cart used for regular purchases remain basically unchanged. The new gift process can be viewed as an extension of an existing buying process interrupted after the purchase of the gift certificate was completed but before shipping address for the gift items is input. At the interruption point, a pointer related to the gift is saved and the USN is created and transmitted to the gift giver. Entering the USN during a redeeming session reloads the purchasing session at the point where it was interrupted. According to this method, the gift giver is responsible for transmitting the USN and the redeeming site information to the gift recipient. Besides the gift delivery address, the gift recipient may also be able to adjust some of the information entered during the first session by the gift giver, for example, by changing gift items or gift delivery methods. The gift recipient can also transmit or forward the gift certificate to another person who can then redeem it.

Since, at redeeming, the gift recipient provides a shipping name and address, this information, available from the carrier and store records, can be used to trace and/or otherwise document the shipment. The store will then be able to provide the name, email, or street address of the person who took delivery of the gift in case there is a dispute. For added security, especially for higher value items, the gift recipient billing information can be collected to document shipping identity even if the card is not charged (this kind of data collection without charging is currently used by repair centers (like Canon) when they take a preliminary repair order before they receive the product, or by airlines who can retrieve the name of a passenger when the credit card is swiped without being charged).

It is, in general, against gift giving tradition to refund the money back to the gift giver or to provide cash to the gift recipient. If cash had been intended, a gift card would suffice. However, similar to a common retail store practice, store credit can be available. Nevertheless, the refund and exchange policy is ultimately at the store's discretion.

Embodiments of the invention shows that, as opposed to existing online gift purchase methods, it is not really necessary to input full gift recipient information during the gift certificate purchasing session. At the time the gift certificate is issued, the store does not need to know information about the gift recipient, except, possibly, a generalized address or location for calculating estimated shipping costs. Nevertheless, some processes may allow data about the gift recipient to be entered during the purchasing session. However, according to the present method, this data would be for reference purposes only and is neither required nor used for actual delivery. Incorrect inputs of reference data, if entered, should therefore not affect the process. For example, if the name of the gift recipient is input to appear on the gift certificate, using a nickname or the like would not affect the gift giving process. Only the delivery information provided by its owner, the gift recipient, is used and needs to be accurate and complete.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a block schematic diagram illustrating one embodiment of system components and associated method operations implemented by a system for facilitating gifting in accordance with embodiments described herein;

FIG. 2 is a flowchart illustrating operations for facilitating gift selection and purchase via an electronic storefront, according to one embodiment;

FIG. 3 is a flowchart illustrating operations and logic for facilitating gift redemption via an electronic storefront, according to one embodiment;

FIGS. 4a and 4b depict representations of exemplary configurations of a shopping cart Web page;

FIG. 5a is a representation of an exemplary gift form;

FIG. 5b is a representation of an exemplary gift certificate customization form;

FIG. 6 is a representation of an exemplary gift shopping cart form;

FIG. 7 is a representation of an exemplary payment form;

FIG. 8 a representation of an exemplary gift certificate delivery method form;

FIG. 9 a representation of an exemplary review order form;

FIG. 10 is a representation of an exemplary gift certificate;

FIG. 11 a representation of an exemplary gift redemption form;

FIG. 12 a representation of an exemplary shipping form;

FIG. 13 is a representation of an exemplary final balance page;

FIG. 14 shows table including a matrix of operations performed by various parties during a gifting process in accordance with embodiments herein;

FIG. 15 is a schematic block diagram illustrating an exemplary 3-tier architecture for implementing an electronic storefront, according to one embodiment;

FIG. 16a is a frontal isometric view of an exemplary blade server chassis in which a plurality of server blades are installed;

FIG. 16b is a rear isometric view of the blade server chassis of FIG. 16a;

FIG. 16c is an isometric frontal view of an exemplary blade server rack in which a plurality of rack-mounted blade server chassis corresponding to FIGS. 16a and 16b are installed; and

FIG. 17 shows details of the components of a typical server blade, according to one embodiment.

### DETAILED DESCRIPTION

Embodiments of methods and apparatus and systems for purchase and delivery of gifts via online transactions are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In accordance with aspects of the invention, a method and apparatus and systems for facilitating the method are disclosed that simplifies current online physical gift purchasing processes and is less prone to information input errors. The critical gift certificate and gift item delivery information which, if entered erroneously can delay or even compromise the gift, is input only by the person most familiar with it, the person to whom it belongs. This makes the process of gift giving more robust and, at the same time, easier to use. The novel method also encourages personal handing of the gift certificate for a more personal gift giving experience. At the same time both the gift giver and the gift recipient have the chance to browse the entire store catalogue. The method can be applied by a regular online store as it does not require a gift specialized database.

As used herein, methods, operations, apparatus and systems relating to an ‘online store’ may be facilitated by an online store (and/or operator of the online store) itself, as well as methods and operations performed by an online store together with its affiliates or third party associates that may facilitate services to customer of the online store. For example, in one non-limiting example a gift purchase process may be facilitated via an online store (through its web services), while a gift redemption process may be facilitated by an affiliate of the online store or a third party acting in cooperation with the online store.

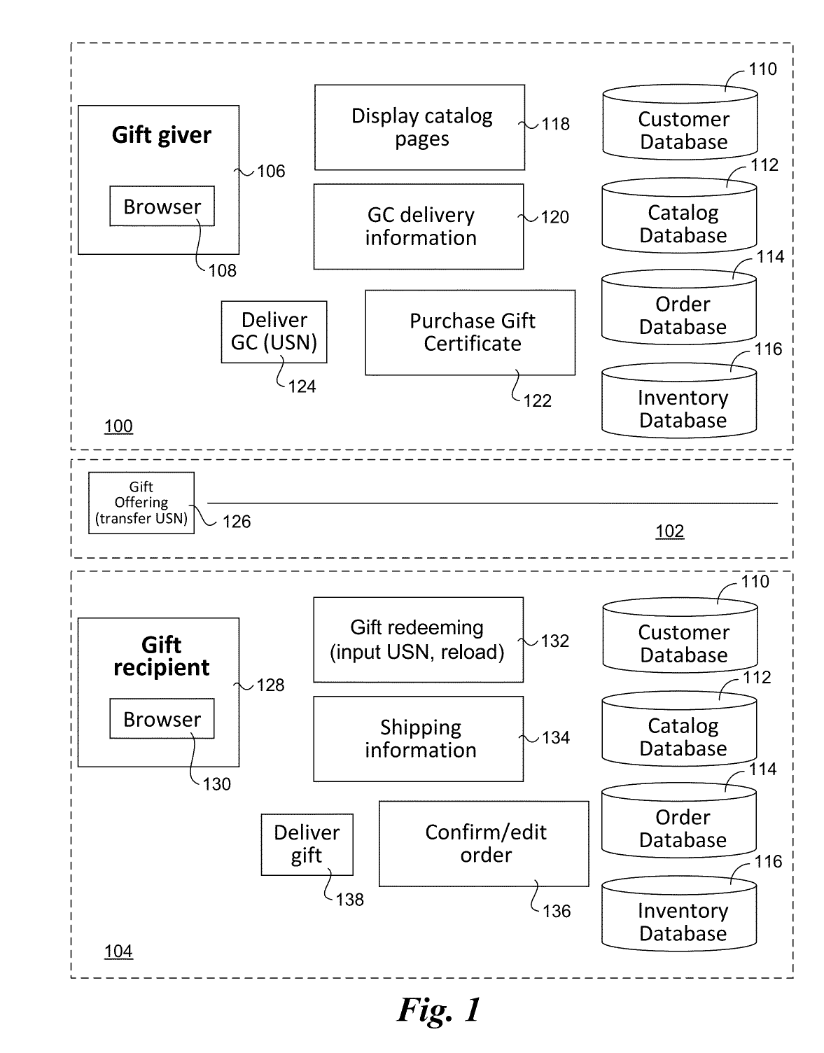

FIG. 1 is a composite block diagram illustrating both system components and associated method operations facilitated by corresponding system components, according to one embodiment. The diagram is logically divided into three sections 100, 102, and 104, as shown. These three sections correspond to a high-level overview of corresponding method operations, which comprise 1) gift selection and purchase and related operations (section 100); 2) transfer of gift redeeming information to the gift recipient (section 102); and 3) redemption of the gift(s) and related operations (section 104).

Section 100 depicts various operations and components related to selecting and purchasing a gift via an online store (also referred herein as an electronic storefront or e-commerce store or Web site), as will be discussed in further detail below. These include a gift giver 106, who accesses the online store Web site (or a third-party facilitator web site that provides gift ordering services for the online store) via a browser 108. The online store maintains information in various databases, including a customer database 110, a catalog database 112, an order database 114, and an inventory database 116. The catalog database and appropriate application, middleware and Web front-end software (not shown) is used to generate and serve Web pages to browser 108. Operations related to the generation and serving of Web pages and associated Web page content are depicted by a display catalog block 118, a gift certificate (GC) delivery information block 120, a purchase gift certificate block 122, and delivery of gift certificate block 124.

As discussed above, section 102 relates to the transfer of gift redeeming information to the gift recipient. This operation is represented by a gift offering block 126, and is described in further detail below.

Section 104 depicts operations and components related to redemption of one or more gifts associated with purchases of gift certificates. These include a gift recipient 128, who accesses the online store web site (or a third-party facilitator web site that provides redemption services for the online store) via a browser 130. Also depicted are a gift redeeming block 132, a shipping information block 134, a confirm/edit order block 136, and a deliver gift block 138. As before, various data related to these operations are stored in customer database 110, catalog database 112, order database 114, and inventory database 116.

Part I: Gift Selection and Gift Certificate Purchase

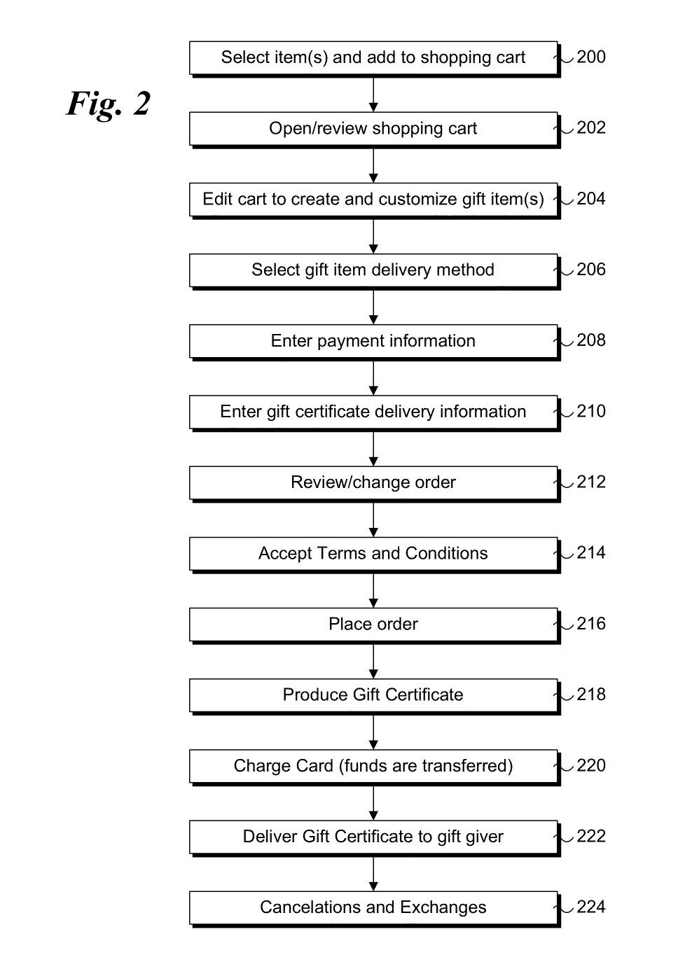

Operations for facilitating gift selection and purchase, according to one embodiment, are illustrated in the flowchart of FIG. 2. The process begins in a block 200 in which one or more selected items are added to the users shopping cart. Typically, the process would begin with the user accessing the online store web site, browsing various pages of the store catalog and adding items to a shopping cart in the conventional manner. At this point, items are added to the shopping cart without initially differentiating between regular purchases (personal—non gift items) and items intended for gifts. To add an item the ‘Add to Cart’ button or the like is selected by the user. In another embodiment, not presented here, the gift items may be added to a special ‘Gift cart’ with an ‘Add as a gift’ button while regular purchase items are added to the regular ‘Shopping cart’ using the usual ‘Add to Cart’ button.

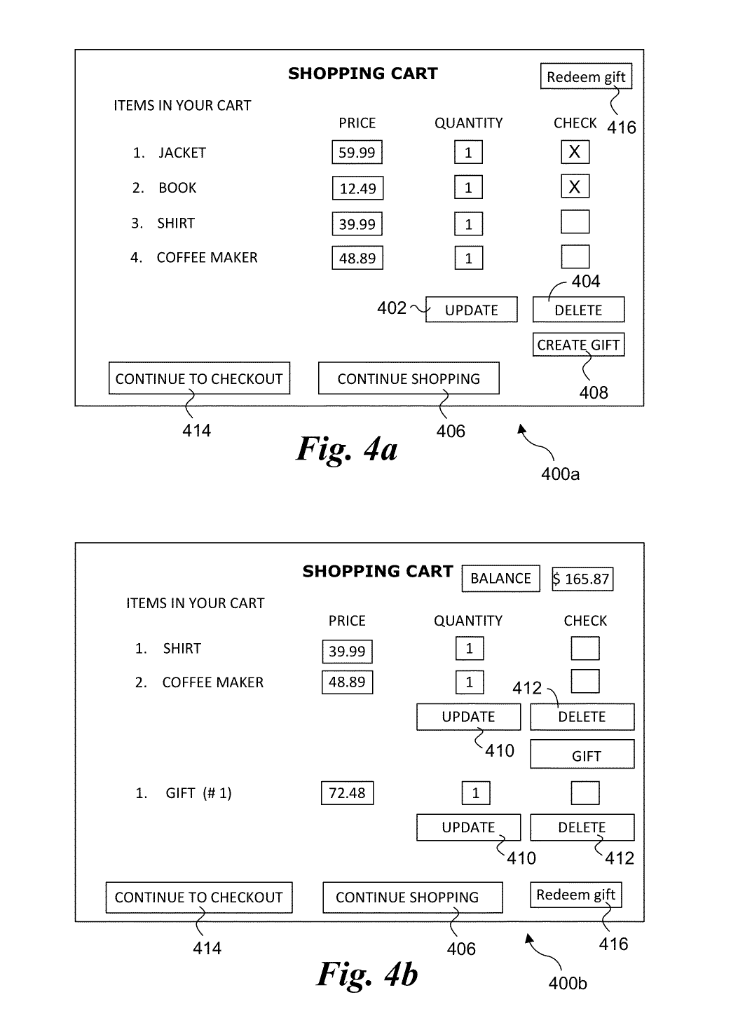

The next operation begins with the user reviewing the shopping cart, as depicted by a block 202 in FIG. 2. When selection is completed or when, at any time, a user likes to review or modify the selection, a ‘View Cart’ button or shopping cart icon may be selected via the user's browser. An exemplary depiction of a shopping cart page 400a after four items have been selected is shown in FIG. 4a. Upon being presented with the shopping cart page, the user is enabled to update quantities and create the gift items. Quantities can be modified by changing the number in the ‘Quantity’ column for one or more items and selecting an ‘Update’ button 402. Items can be deleted by checking the corresponding box in the ‘Check’ column and selecting a ‘Delete’ button 404 or by setting ‘Quantity’ to ‘0’ and selecting ‘Update’ button 402. To add more items to the cart, the user may select a ‘Continue shopping’ button 406, which returns the user to the catalog, where more items can be selected and added to the cart.

In association with viewing the shopping cart, the user is enabled to edit the cart and create and customize one or more gift items, as shown in a block 204. To create a gift item, shopping cart articles are selected by checking the corresponding ‘Check’ column box or boxes and selecting a ‘Create Gift’ button 408. In the illustrated embodiment the ‘Check’ column is a double function column depending on whether ‘Delete’ button 404 or ‘Gift’ button 408 is selected. Alternatively, three columns can be provided labeled ‘Quantity’, ‘Delete’, and ‘Create Gift’ with a common ‘Update’ button.

In response to a first selection of ‘Create Gift’ button 408, a gift section is created below the regular items, and a gift comprising one or more items corresponding to item rows having the box checked in the ‘Check’ column is thus created. A depiction of an exemplary updated shopping cart page 400b showing one gift item including a Jacket and a Book is shown in FIG. 4b. The regular items assigned to the gift are subtracted from the quantities in the regular item section, such that they are removed, as shown in updated shopping cart page 400b.

The quantity of each gift item may be changed by changing the number in the ‘Quantity’ column box for the item and selecting an ‘Update’ button 410. A gift item may be deleted by placing a check in the ‘Check’ column and selecting a ‘Delete’ button 412. Generally, additional gifts may be added by selecting one or more of the regular items via the ‘Check’ column boxes and selecting ‘Create Gift’ button 408. Each additional gift item is added as a new row that is placed below any existing row(s) of previously added gift items, with a corresponding gift item number added.

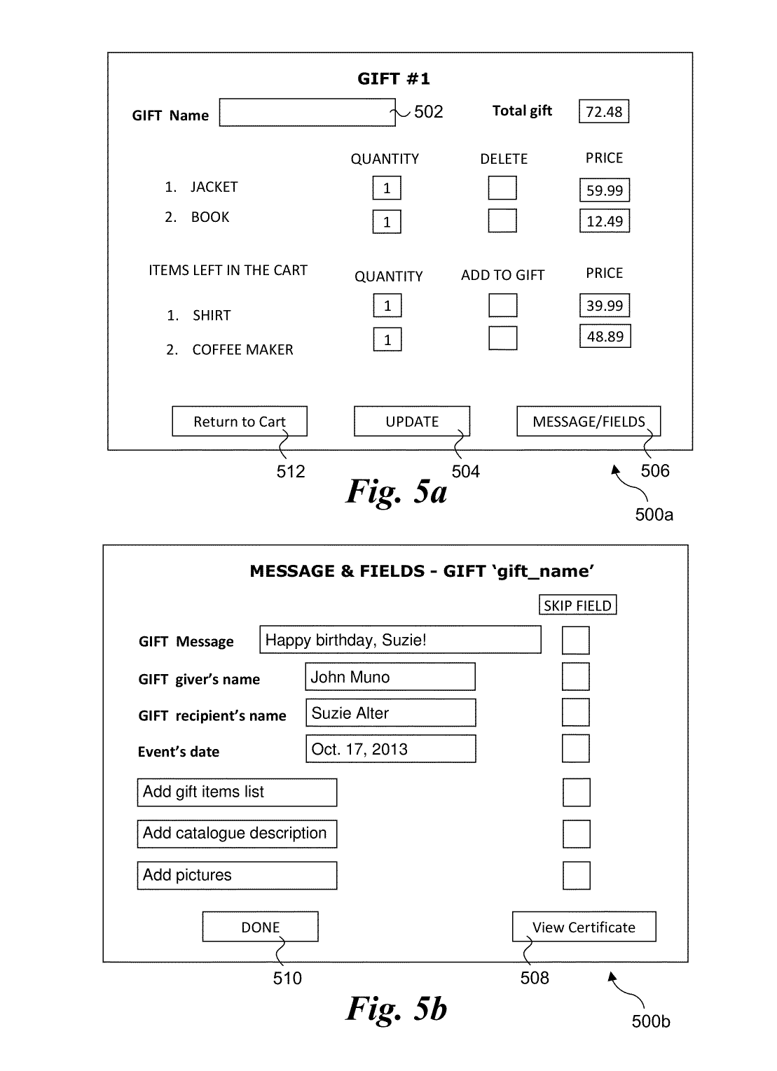

A gift item can be edited by clicking on the gift item name. This will open a ‘Gift’ form, such as depicted by an exemplary ‘Gift’ form 500 in FIG. 5a. The ‘Gift’ form lists the name of the gift, which initially is a number. The name can then be changed to something easier to identify, like ‘Suzie's Birthday’, by editing a ‘Gift Name’ box 502. The first part of the form lists the items that are already part of the gift and the total prices for each line item. The total gift price is listed next to the ‘Gift name’ box.

The quantity of each item belonging to the gift can be changed by changing the number in the corresponding box. Similarly, the item can be removed by checking the ‘Delete’ box. More items can be added to the gift by checking boxes in the ‘Add to gift’ column. The added quantities can be changed by changing the corresponding numbers in the ‘Quantity’ column. This will also be reflected in the ‘Price’ column. The page is updated and changes take effect any time ‘Update’ button 504 is selected.

A gift certificate can be customized with various information. Selecting a ‘Message/Fields’ button 506 brings up a Gift Certificate customization form 500b, one embodiment of which is depicted in FIG. 5b. As illustrated, Gift Certificate customization form 500b enables users to customize a gift certificate, such as entering a personal message like “Happy birthday, Suzie!”, the name of the gift giver, occasion, date of the event, date of purchase (this may be automatically included for holding time and exchange), name of the gift recipient, etc. The gift item names (as listed in the store catalog) and possibly description and pictures of the gift items can be included by clicking the appropriate buttons, such as ‘Add gift item list’, ‘Add catalogue description’, and/or ‘Add catalogue picture’. The estimated time for delivery may also be included based on the shipment method chosen by the gift giver and the store gift shipment period. Selection of a ‘View Certificate’ button 508 enables the user to have a quick view of how the gift certificate will appear. A dummy USN can be shown at this stage. In general, for convenience, one would try to stay within a single page. A date indicating how long the gift will be on hold may be included, which can be, for instance, seven days after the gift was purchased. The actual date will be filled at the time the gift order is placed. In one embodiment, if the gift certificate is not redeemed within the holding time interval, the gift item(s) will revert to availability and prices corresponding to regular store items. After all editing is completed and the gift giver is satisfied with the gift certificate content, selecting a ‘Done’ button 510 saves the gift certificate format and returns the user back to the Gift form 500a. Once the gift item is configured as desired, selecting a ‘Return to cart’ button 512 causes the browser to return to the Shopping Cart page.

If more of the same gift items are wanted, the quantity can be changed by going back to the ‘Shopping Cart’, changing the number in the quantity box to the desired number and selecting ‘Update’ button 410. More gift items will appear. If the replicated gift name has been changed, the names of the replica gifts can be set to ‘original gift name’ plus a number in succession starting with ‘1’. If the gift name was a number (originally assigned name), the newly created identical gifts will have incremental numbers. The numbers can be incremented starting from the replicated gift number which means that the other gift numbers, if they exist, will be incremented by the number of newly created gifts so that they have unique numbers. Individual gift items may be edited by clicking on the gift item name.

In general, the shopping cart remains accessible throughout the whole shopping process and can be edited by changing quantities or deleting items. More items can be added to the gift items by first adding them as regular items to the shopping cart, and then following the process described above.

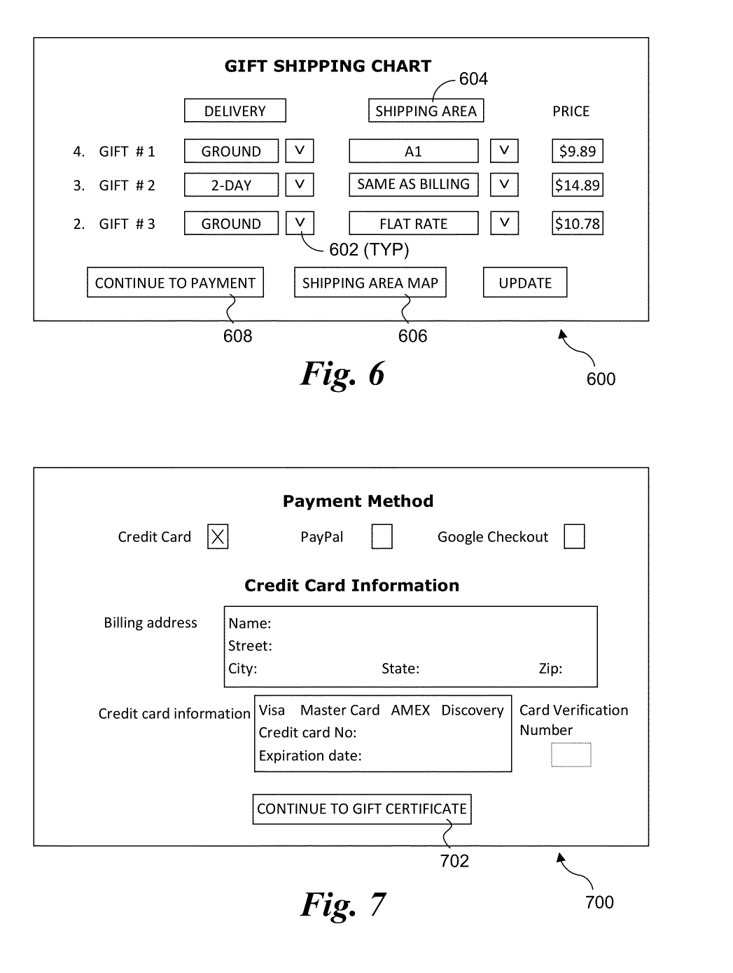

Returning to the flowchart of FIG. 2, the next operation is to select the gift item delivery method, as depicted in a block 206. Selecting a ‘Continue to Checkout’ button 414 in the Shopping cart opens a ‘Gift Shipping Chart’ form 600 shown in FIG. 6 for selecting the delivery method for the gift item (not to be confused with the Gift certificate delivery method discussed below). Since the exact shipping address may not be known during the gift ordering process, one can make a best guess for the shipping cost. Alternatively, the store may offer a unique rate applicable to all destinations for a certain delivery method.

In general, a few options can be made available to the gift giver. For example, even if the user does not know the exact street address, he/she may have a good idea of the general area where the gift recipient is located. Usually one can point the shipping destination at a state-level resolution and even down to county or city/town level. This should be enough to determine the shipping rates as weight and size of the gift are generally available from the store, as well as the location the gift is shipped from. A map indicating the zones having the same shipping rate can be shown by selecting button 606 based on data from the carrier. In case a gift has more than one item with some items shipped from different locations, constructing the shipping area map may be more involved and may have more different rate areas. This will generally be no different than how multiple item orders are currently handled by online stores.

Each gift item has two columns, one for ‘Delivery’ method and one for ‘Shipping area’, each having a pull-down menu 602. The user can chose the preferred delivery method by pressing the corresponding menu button. For example, delivery options may include Ground, 2-day, 3-day, Overnight, etc. In case the gift is intended to be picked up at a retail store and can be made available there, ‘Store pickup’ is chosen. If the item is in general available at the store no shipping is charged. If the item needs to be shipped to the store, shipping might be charged. Shipping area information can show the constant rate shipping areas named as read from the ‘Shipping area map’ in a convenient way, for example, A1, A2, . . . B1, B2, . . . where the letter may mean horizontal (east-west) division and the numbers vertical divisions (north-south). For fewer zones, the nomenclature can be simpler; e.g., zones I, II, and III. Alternatively, a list of states that make up a shipping area can be selected from a corresponding pull-down menu. A common situation is when the gift recipient address is close to the gift giver address. In this case ‘Same as billing’ can be chosen. A ‘Flat rate’ option may also exist, where the store by itself or in agreement with one or more carriers may offer a single rate to cover all possible shipping destinations. This is a safe choice in any situation especially if one is not sure about the shipping destination or wants to make sure there will be no problems in case the gift recipient chooses to ship the gift to another destination.

The next operation in the flowchart of FIG. 2 is entry of payment information depicted in block 208. In one embodiment this may be initiated by selecting a ‘Continue to payment’ button 608 in ‘Gift Shipping Chart’ form 600, which opens a page for inputting payment information. Usual payment methods can be offered by the store, including Credit Card, PayPal, Google Checkout, Electronic Check, Bill Me Later, Paysafecard, etc. Depending on which payment option is chosen, a form for entering the appropriate information is presented. For example, FIG. 7 shows a user interface for a payment form 700 that is presented in response to selecting Credit Card as the chosen method of payment. Payment form 700 depicts various fields and selections typical of credit card payment forms, via which the user would enter appropriate information. Optionally, if a sign-on scheme is used, information such as billing address may be pre-populated, and one or more registered credit cards may be select through use of a corresponding user interface, such as radio buttons, pull-down menus, etc. After completing the application payment information the user may select a ‘Continue to Gift Certificate’ button 702 to navigate to a new page via which gift certificate related information may be entered. Alternatively, the applicable fields and user interface objects may be included below the payment information in payment form 700 (not shown).

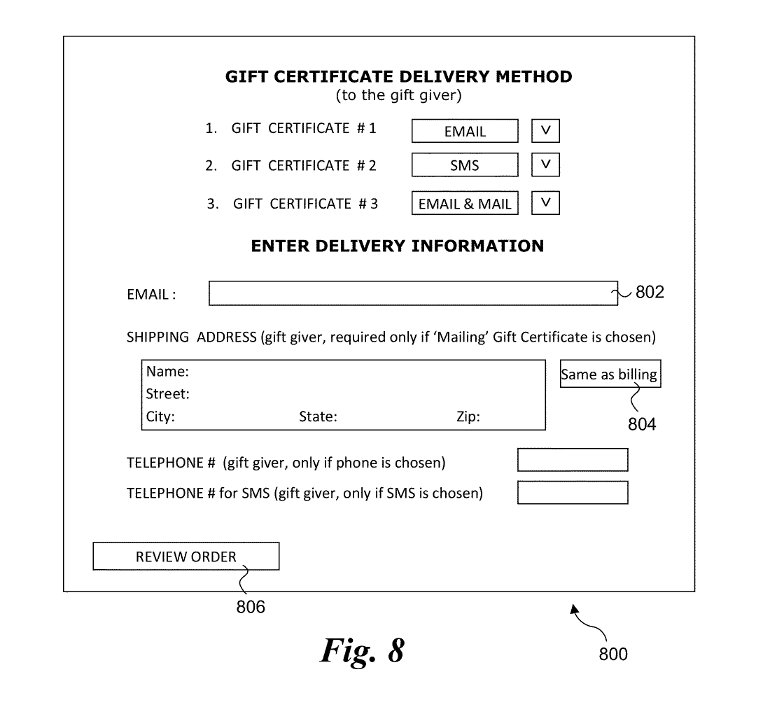

Gift certificate delivery information is next entered, as depicted by a block 210. In one embodiment, a gift certificate delivery method may be chosen for each gift from a pull-down menu in a Gift Certificate Delivery Method form 800 shown in FIG. 8. There are a variety of possible delivery methods that may be provided by the online store, such as Email, Mail, Secure Email, Instant web page, Telephone, SMS, FAX, etc. Information relating to the selected delivery method is entered using the Gift Certificate Delivery Method form 800. It is noted that Gift Certificate Delivery Method form 800, as with other forms presented herein, has a flexible user interface in which different information, form fields, and UI controls are presented depending on related user-selected options.

For delivery by email, the gift certificate may be delivered as an electronic attachment (e.g., in PDF format) containing the USN and the additional optional information as entered by the gift giver in gift certificate customization form 500b, which is sent to the gift giver at a user-provided email address into an e-mail address field 802. The attachment may then be either printed for in-person delivery, or forwarded by email. The gift certificate can also be delivered by mail as a paper copy to the gift giver, who can then deliver it in person to the gift recipient. The gift certificate may also be produced as a web page on the store server, which can then be accessed by the client browser (the gift giver in this case) on the screen and can be printed or saved on the hard drive for subsequent electronic delivery. This can be part of the secure network connection already established during the purchase. The gift certificate can also be faxed.

A secure email method sends the gift certificate by email followed by a private code which will appear in the current session over a secure network connection and is required for redeeming the gift. This code is shorter than the main USN. It can be, for example, 3 or 4 digits long, such that it could be easily handwritten on the certificate or a separate piece of paper. Sometimes, for convenience and assurance of delivery the gift certificate can be sent by two methods simultaneously, for example, ‘SMS and Email’, or ‘Email and Mail’. Under this situation, applicable combinations would also be included in a pull-down menu. If delivery fails, having the gift certificate resent may require having or creating a membership account with the store or contacting the store's Customer Service.

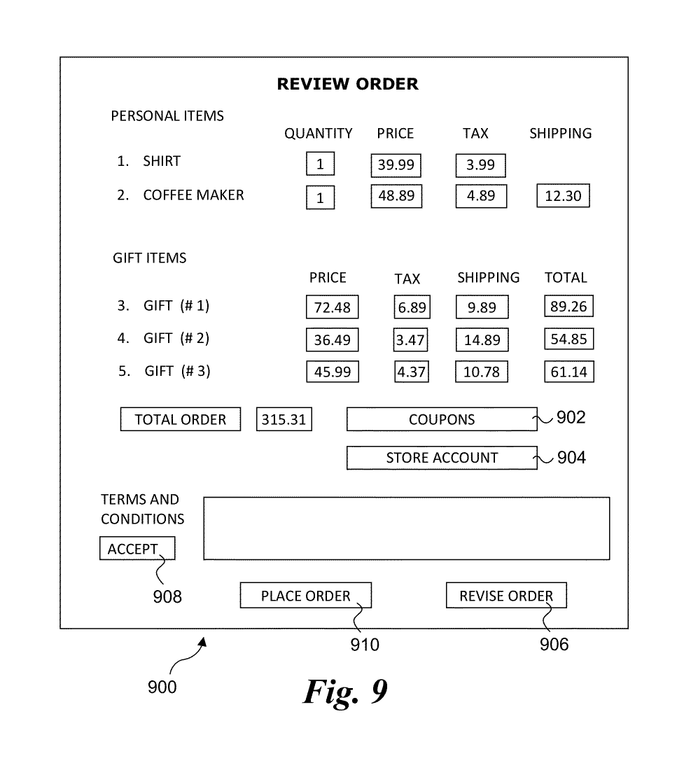

Following entry of the gift certificate delivery method, the user is presented with a review/change order form, as depicted in a block 212. An example of a Review Order form 900 is shown in FIG. 9. Another aspect of reviewing an order is calculation and presentation of applicable sales tax information, along with total purchases prices for each gift item.

Conventionally, sales taxes for online transactions are typically based on the address (typically state) of the recipient, e.g., the shipping address entered for the transaction. According to the some embodiments, the gift certificate, which is the object of the purchase transaction, is delivered to the gift giver whose physical address is either already known or can be required. For all practical purposes, the gift recipient is not known (by the online store) at the time the gift certificate is delivered. In one embodiment, taxes are based on the location of the gift giver. For this purpose, the residency information of the gift giver may be required even if just email delivery is selected. Generally, this information may be entered as full address or just city/town and state or postal zip code, enough to be able to determine the amount of sales tax. The applicable residence address could be derived from the shipping address entered (as applicable) on Gift Certificate Delivery Method form 800. Alternatively, if a billing address was entered, in can be used for tax purposes as well. In this case, the shipping address can be automatically populated by selecting a ‘Same as billing’ button 804.

Once the gift certificate delivery information is entered and a ‘Review order’ button 806 is selected, the total prices for all regular purchase items and for each gift item, including sales tax and shipping and handling are shown in Review Order form 900. Optionally, store coupons and/or a store balance can be applied toward the order using a ‘Coupons’ button 902 and a ‘Store account’ button 904. If changes are needed, the user can return to the shopping cart by selecting a ‘Revise order’ button 906.

The next operation in the flowchart of FIG. 2 is accepting the Terms and Conditions, as shown in a block 214. To place the order, a ‘Terms and Conditions’ agreement needs to be accepted (and preferably read), which is indicated by the user by selecting an ‘Accept’ button 908 on Review Order form 900. The agreement can cover both regular purchases and the particular aspects of gift purchases. Some conditions the gift giver would need to agree to are, for example, when the credit card is charged and that it is the gift giver's responsibility to hand the gift certificate to the gift recipient and for the gift recipient to redeem the gift. The agreement may specify a limited hold period, such as the gift will be on hold for, for example, 7 days after the gift is purchased. After that the gift items will revert to regular store articles subject to availability and current store prices. Gift items can be exchanged online with other store items at the time of redeeming. Also, the terms and conditions may specify that after shipping of the gift to the gift recipient, the regular Return & Exchange policy takes effect (for example 30 days after delivery for general articles, etc.). The terms and conditions may also specify various legal considerations, such as the conditions under which credit cards are charged, various remedies for disputes, legal forums, etc.

After the terms and conditions have been accepted, the user may select to place the order by selecting a ‘Place order’ button 910. The corresponding flowchart operation is depicted in a block 216. In response to selection of ‘Place order’ button 910 the order is sent, which entails the following. First, any order information that hasn't been previously sent to the server hosting the store web site (or applicable server for the session) is sent to the server and stored in order database 114. The store checks its inventory information (e.g., by querying inventory database 116) to confirm any applicable item associated with the purchase are still in stock and/or can be delivered in a reasonable time. The inventory will be modified by putting the item on hold (reserved) if the item is in stock or, if from a vendor, the information needs to be sent so that the vendor can make plans for a pending final order (after redeeming) accordingly.

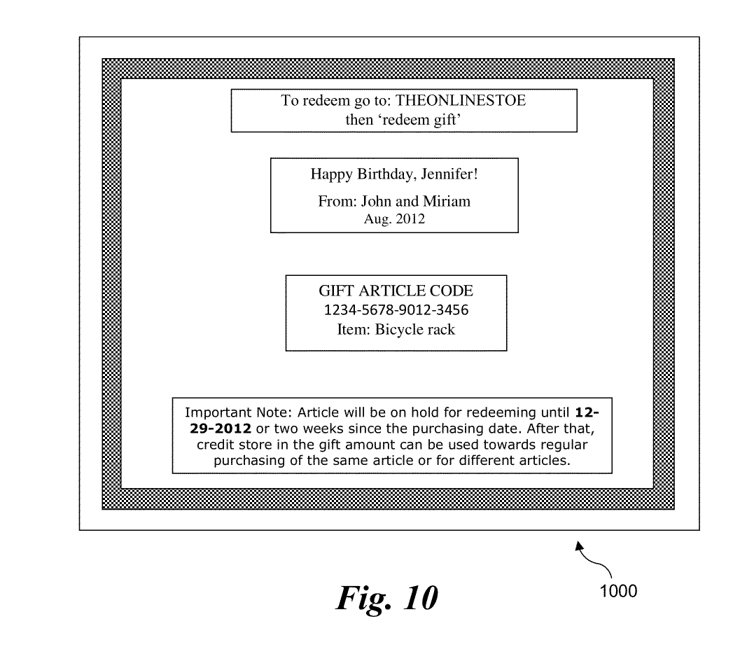

After the order has been placed, a gift certificate is generated, as depicted in a block 218 of the flowchart of FIG. 2. The gift certificate contains the newly created Unique and Secure Number (USN) and the other fields populated based on prior input entered by the gift giver in the Gift Customization form 500b. In one embodiment, a dynamic web page construction process is used. An example of one embodiment of a gift certificate is shown in FIG. 10. The illustrated gift certificate includes the USN (the Unique and Secure Number associated with the gift article), a brief description of the item, name of the store for redeeming the gift, and the other information as previously provided by during the purchase process. If no information is provided for a particular field, that field may be left blank or can be removed from the gift certificate. If the fields are left blank, the information can also be entered by hand on a hard copy of a gift certificate. It is also possible to have a blank Gift Certificate form, or a Gift Certificate form with a partial USN, wherein the remaining part of the USN is sent by telephone, SMS, or other secure methods. The USN or the additional code can then be handwritten on the gift certificate form before handing it to the gift recipient. The latter option can be perceived by some as more secure since the USN or the security code are not sent by email where there is a chance they can be intercepted. Another way to enhance security is to write the USN using CAPTCHA characters which are, in general, not machine readable. Further discussion of aspects relating to transaction security is provided below.

A gift certificate may be valid for a certain period of time, such as, for example, one year, or may never expire. This depends on the store policy and might be affected by regulations, similar to state regulations that do not permit gift cards to expire. Expiration information may be stated on the gift certificate itself, and/or could be part of the Terms and Conditions agreement discussed above.

Once the gift certificate is ready for delivery, the credit card is charged, as depicted in a block 220 of the flowchart. It is noted that similar operations apply to other forms of payment, such as PayPal, store credit, etc. Typically, the validity of the card information will be checked when the billing information is entered. In this instance, the transaction is for a gift certificate in either electronic or paper format, which is considered as an actual article produced, sold, and delivered by the store. Accordingly, generation and sending of an electronic copy of the gift certificate or mailing a paper copy completes the transaction (from the standpoint of a purchase from the store). As used herein, facilitating delivery of a gift certificate corresponds to operations performed by the online store and/or representatives thereof to deliver the gift certificate in electronic or paper form. For example, delivery of the gift certificate via an e-mail as an attachment comprises an electronic means of facilitating delivery of the certificate, while preparing a certificate to be delivered via mail (USPS) or a private shipping service (UPS, Fedex, etc.) constitutes facilitating delivery of a paper form of the certificate. Facilitating delivery of the paper form of a gift certificate itself does not entail the actual delivery service performed by the USPS or a private shipper. Similarly, information generated by the electronic store in connection to a gift certificate transaction that is forwarded to a third party to send out the actual e-mail and attachment likewise comprise facilitating delivery of the gift certificate in electronic form.

If a credit card method of payment is used, the card can be first pre-authorized. This will typically involve the usual steps for confirming a regular online purchase. In one embodiment, only after the gift item(s) availability is checked and order status is confirmed will the request for charging the card be submitted and the gift certificate is cleared for being sent to the gift giver. The card is charged and the funds are transferred in a manner similar to a regular purchase of goods or services via credit card.

Once purchased, the gift certificate is delivered to the gift giver via one or more methods previously selected during the purchase process, as described above and depicted in a block 220 of the flowchart. These include sending the gift certificate as an email attachment or, instantly, as an image or object embedded in a web page that may be displayed in a browser window on the gift giver's monitor, wherein the web page and/or the embedded image/object may be printed and/or saved on the user's computer (e.g., on a local hard drive). It is also possible to send a web page containing a link to a PDF document to a web browser on the client device used by the gift giver, whereby the browser will retrieve the PDF content via the link and display the gift certificate as a web page via use of a PDF reader plug-in. There are situations when a printer is not available or a user's email account cannot be accessed. In such a case, the gift USN can be transmitted over the telephone by an automatic system or by a live agent, or sent as a text message (SMS) to a mobile device (again, either automatically or via a live agent). The telephone or SMS methods are fast and secure, but they do not usually result in a finished-looking gift certificate format. In such cases, to ensure the customer has received the gift certificate information, an email can be sent to the gift giver (if the email address was previously entered or is otherwise stored in Customer database 110), to inform the gift giver about the telephone or SMS message. To facilitate navigation to the redeeming site, a hyperlink containing the web address were the gift is to be redeemed can be included with the email message.

As for most online purchases, it is possible to make cancelations and exchanges before an item has shipped or has entered a shipping preparation process. With the system disclosed in the present invention, since the shipping address is not initially known, the gift item will not enter shipping preparation until the gift item is redeemed by the gift recipient. For example, instead of making an exchange, stores will often prefer to cancel an old order and place a new order for the new item. This allows for an extended period for cancelations or exchanges.

At this stage, the request for cancellation or exchange will be initiated by the gift giver. This might be facilitated through an online form or forms, or through use of customer service (either automated or through use of a customer service agent). Operations related to cancelations and exchanges are depicted in a block 224. Performing an online cancelation or exchange may require an open account so that the online store can access the order history. Exchanges and cancellations may trigger issuing a new gift certificate with a new USN or, especially useful if the gift certificate was already handed to the gift recipient, may keep the same USN. This may require a disclaimer in the Terms & Conditions agreement or on the gift certificate itself that items listed on the initial gift certificate may change, in general, due to a Cancellation or Exchange by a gift giver. Exactly what order changes may qualify for an exchange or a cancellation will typically be defined by the online store policies. The period during which the gift can be canceled for a refund or the gift can be changed may be limited even if it has not yet been redeemed. Since a credit card or other payment means has already been charged, a cancellation will typically result in a refund credited to the payment source, potentially deducting an additional charge as a change fee or cancellation fee.

Facilitating delivery of the gift certificate completes the first (purchase) part of the gift purchase/certificate transfer/redemption process. As discussed above, the purchase process has most of the components of a regular online purchase. The store makes a sale and the customer purchases an article—the gift certificate. The store ensures products corresponding to the gift items are projected to be available when redeemed by the gift recipient, such as for a specified period of time (e.g., 7 days, 14 days, 30 days, etc.). Alternatively, if a third-party vendor is involved in providing one or more of the items, the vendor may be notified to put the item(s) on hold, send to production, or order the item(s) (as applicable). Additionally, upon purchase of the gift certificate, the corresponding purchase transaction is closed, with the amount cashed by the store and the gift giver in possession of the redeemable gift certificate (once it is electronically and/or physically delivered). Thus, according to the present embodiment, the store is relieved from any other actions until the recipient redeems the item.

According to aspects of the invention, one benefit that distinguishes this novel process from existing methods is that the gift giver does not need to enter a gift recipient's contact information (e.g., shipping address, email address, etc.), which may not be readily available and is prone to inaccuracies. This simplification of the process significantly reduces the effort and time required to place the order and avoids mistakes that can occur when entering unfamiliar gift delivery information. A user can have a gift certificate produced in just minutes, allowing additional time to prepare, for example, for an upcoming event like a birthday party, without having to frantically look for information the user does not have readily available or is unsure about, and without later worrying about the accuracy of the information just entered and doubting if the gift is actually going to be delivered. This fast and stress-free purchase is combined with fast and flexible delivery options.

Because the responsibility of finalizing the delivery is shifted to the gift giver and later to the gift recipient, the store is under no obligation to contact the gift recipient to make sure the gift is delivered. Also, the store should be able to obtain payment at the time when the gift order is placed instead of waiting until the actual gift items are shipped. This reduces store operating expenses and provides cash that can be used to replenish store inventory.

Part II: Gift Giving—Transfer of Gift Certificate to Recipient

Once in possession of the gift certificate in either paper or electronic form, the gift giver can provide the gift certificate to the gift recipient. This can take place either physically by personally handing a hard copy of the gift certificate to the recipient or electronically, by forwarding an email from the store containing the gift certificate and possibly a hyperlink to the redeeming site to facilitate redeeming. In one embodiment, after the gift certificate purchase is completed, the store may offer to send an email to the gift recipient containing the gift certificate as a courtesy service. In this case the gift giver needs to provide the gift recipient's email address. However, this is not part of the purchasing process and at the store's discretion to implement and to make sure the customer, the gift giver, understands that the responsibility of delivering the gift certificate is his/hers and not the store's. For example, according to one embodiment, the store is not responsible if, for some reason, the email does not reach the gift recipient as it may be the case when the store email is directed to a junk mail directory or the email provided was invalid, obsolete, or was not for the correct person.

The more personal a gift is made, the bigger the satisfaction on both the giver and recipient sides. Even a relatively small gift may have more meaning when given in person than a large gift sent by email, a third party, or other methods. Offering a specific gift goes beyond a gift card with a monetary value since it shows the personal attention given in selecting the gift. A fixed value gift card presents an inconvenience in that it finally needs to be converted to an actual store item purchase. If the amount on the gift card is less than the gift amount, the gift recipient has to cover the difference. If the value on the gift card is more than the gift amount the gift recipient is pressured to select an additional item, that may not have been wanted, or keep the card until a need arises by which time the card can be lost or forgotten. When an additional item is chosen, it may be likely the value on the card is exceeded and the gift recipient has to contribute his own funds to cover the difference.

Embodiments of the present invention can be used for both in-person gift giving or remotely. For example, a gift giver may provide a gift certificate to a gift recipient when attending a specific occasion, such as a birthday party, baby shower, house warming, etc., wherein a paper copy of the gift certificate can be handed to the recipient or included in a greeting card that is handed or otherwise received at the occasion by the recipient. Alternatively, a gift certificate can be sent (e.g., by email or regular mail) or otherwise a notification can be sent (e.g., via a phone call or text message) for an event or occasion the gift giver is unable to attend in person.

These aspects of the invention offer a more memorable experience for both the gift giver and gift recipient, since the gift certificate is personally handed instead of the store handling it by, for example, sending an email to ask for shipping information. There is a psychological association that the gift recipient makes toward the person or business that actually hands out the gift. Having a third party perform this function detracts from the credit the gift giver rightly deserves. On the other hand, stores value interaction time with customers as they may return to the store for future purchases. As it will be seen in the following gift redeeming section, embodiments of the present invention still offer ample opportunities for interaction between the gift recipient and the store.

Another benefit of the invention's methods is the possibility of a more precise timing of the gift relative to the specific occasion. Whether the gift certificate was order in advance or the order is done just at the last moment, the gift giver is able to pick just the right time for presenting the gift for the specific occasion. Relying on the store to announce the gift and request or confirm shipping information can take unexpected turns due to many factors, such as inaccurate contact information, delays in sending the store message, time the gift recipient checks the email, filtering of the store message by the gift recipient's email system. Also, since, with current methods, a gift is, in general, ordered in advance of the specific occasion to leave enough time to reach the recipient, special coordination with the store for the timing of the announcement might be required.

Part III: Gift Redeeming

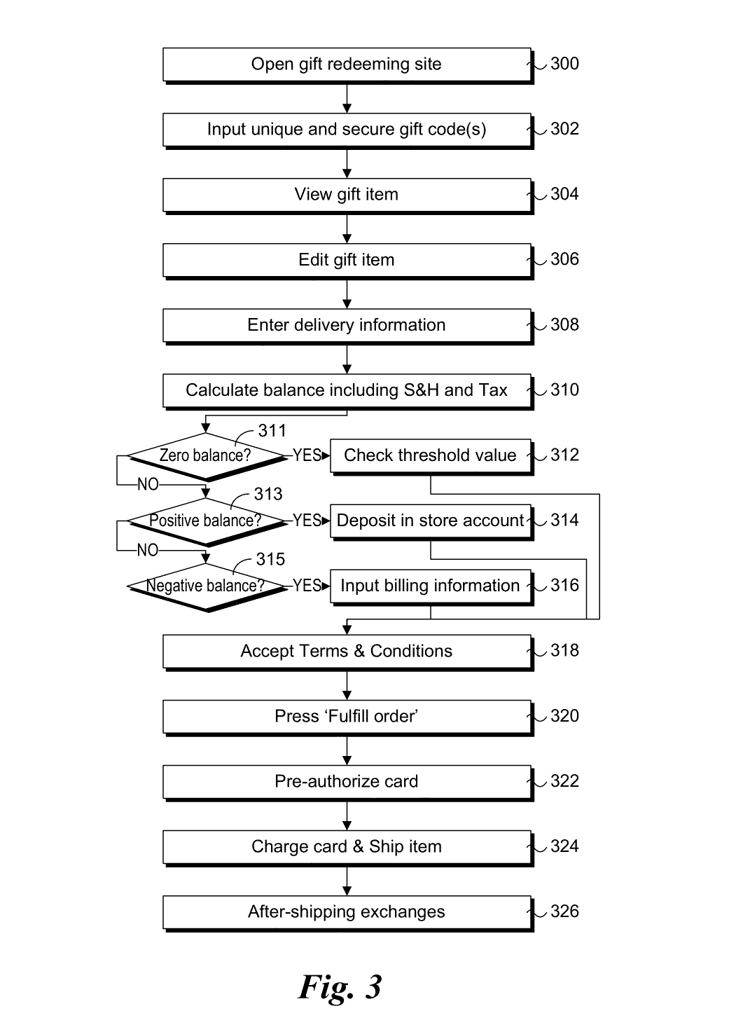

The last part of the gifting process involves the gift recipient redeeming the gift certificate to receive the corresponding gift item(s). As discussed above, the gift certificate contains information for redeeming the certificate, such as the USN code and identity of the store and/or URL for a redeeming web site. Generally, the gift items may be redeemed via use of the gift certificate information using online facilities provided by the online store or a third party, or otherwise via phone using customer service. Optionally, a third party may also facilitate purchasing of the gift certificate by intermediating between the gift giver and the online store. A flowchart illustrating operation and logic associated with redeeming a gift is shown in FIG. 3.

Once in possession of the gift certificate, the gift recipient can, at a convenient time, navigate online to the web site indicated on the gift certificate or otherwise transmitted to redeem the gift, as depicted by a block 300 in FIG. 3. This can be done from any device with Internet access to the online store site, such as from a home computer, office computer or a mobile device, as explained in further detail below. The web site address (URL) identified in the gift certificate may correspond to a particular gift redeeming page (or a home/initial page of a gift-redeeming web site), or it might be the home page of the online store that includes a link to guide the gift recipient to the redeeming page or site. In one embodiment, accessing the redeeming site is done from an online store's home page by selecting a ‘Redeem Gift’ button with an underlying hyperlink to the redeeming site's launch page. In another embodiment, a gift redeeming button can be placed in the ‘Shopping Cart’. In yet another embodiment, a ‘Gift’ button or menu option available in the online store's home page may be employed for both gift purchases and gift redeeming. Also, a hyperlink included in or attached to a gift certificate email may be used to redirect the user's browser directly to the redeeming site.

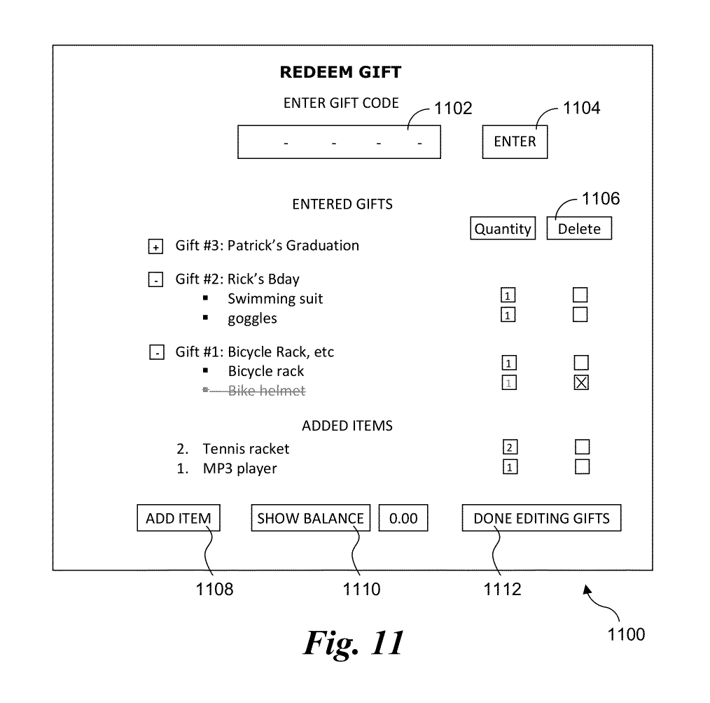

Once at the redeeming site, the next operation is entry of the secure gift code(s) (e.g., USNs), as depicted in a block 302. Upon navigating to the redeeming site, a redeeming web page is presented, such as exemplified by a ‘Redeem Gift’ page 1100 shown in FIG. 11. One or more USN numbers can be typed in via a gift code text box 1102. Upon completed entry of a USN code, the user will select an ‘Enter’ button 1104, which will initiate a validation process to validate the entered code. If the code is valid, the corresponding gift is added to the ‘Entered Gifts’ section and frees gift code text box 1102 for entering another gift code. If the code is not found, an error message appears asking for the code to be reentered. If the ‘secure email’ option was used by the gift giver during the purchase process, another text box for entering a corresponding private security code is also provided (not shown in FIG. 11).

As mentioned above, it is possible, though unlikely, that the gift giver will cancel the gift order before the gift is redeemed. In this case, a message will appear when the gift is redeemed, such as ‘This gift item was canceled by (name of gift giver)’. In case of an exchange by the gift giver, in one embodiment a message similar to the following will appear: ‘The item(s) on this gift certificate have been changed compared with the original order. The new items are . . . ’.

As depicted by a block 304, the gift recipient is enabled to view each gift item via an applicable user interface object. For example, as illustrated in FIG. 11, the listing of the content of each gift can be viewed by selecting the ‘+’ button to the left of the gift item number and gift name. A list of items making up the gift is shown under the gift name. Each gift item in the listing may include a hyperlink to the store catalog page for a more detailed description of the item; clicking on the hyperlink opens a new window showing the store catalog web page for the gift item. In one embodiment, the price of the corresponding item may be intentionally hidden.

As depicted by a block 306, a recipient is enabled to edit a gift item, such as exchanging it or deleting it. ‘Redeem Gift’ page 1100 includes a ‘Delete’ button 1106 that works in conjunction with a check box associated with each individual gift item. In one embodiment, by checking the check box to the right of the gift item and selecting ‘Delete’ button 1106, the item is removed from the list and the respective amount is credited toward future purchases. In order to keep track of the changes, the deleted items are struck through and depicted in a different color, such as a lighter gray. Meanwhile, the checkbox of the deleted item will still be marked as checked (e.g., such as depicted by an ‘X’ sign in FIG. 11). A deleted item can be undeleted by clicking again on the checkbox. This removes the checkmark (e.g., ‘X’ sign) and restores the gift item to the gift it belonged to, adding the gift back to the order balance. As another option, the quantity of the item can be changed by changing the number in the ‘Quantity’ column. Changing a quantity to ‘0’ will result in deletion of the gift.

Another option available to a gift recipient is to exchange a gift item. In one embodiment, to make an exchange, the corresponding gift item is first removed (i.e., deleted) and then replaced by one or more new items. To select a new item, an ‘Add item’ button 1108 is selected. This brings up the store catalogue which can be browsed just as it would for a regular purchase. Selected items are added to the ‘Added items’ list by pressing a ‘Add item’ (or ‘Add to cart’) button which also takes the user back to ‘Redeem gift’ page 1100 to enable further gift editing. Various options such as quantity, size, and color can be specified on the item description line. Quantity can also be modified on ‘Added items’ section of page 1100. Added items can be deleted by using the checkbox to the right of an item and selecting ‘Delete’ button 1106. When deleted, added items are completely removed from the list as opposed to gift item which remain visible. ‘Add item’ button 1108 and ‘Delete’ button 1106 work independently so that a user can add more items and delete as many items as desired. In one embodiment, a gift is nonrefundable but may be redeemed for store credit. Accordingly, if a replacement item is not added or its value is less than the value of the gift item it replaces, the amount of the gift item is deposited in a store account for credit towards future purchases.

To see the balance after changes are made, a ‘Show balance’ button 1110 is selected. This balance does not, in general, take into consideration shipping and handling costs and should start at zero when gift codes are initially entered. Alternatively, the balance can be continuously updated, eliminating the need to press ‘Show balance’ button 1110. At checkout, pre-existing store credit may be applied against a negative final gift balance to lower the total payment.

A positive balance indicates money that can be used towards purchases. A negative balance is an amount that has to be paid for exchanged or added items. If the gift recipient has a user account with the store, the gift redeeming and editing information is saved (by sending updated data to the server) on an ongoing basis, such that if the current session is interrupted the information is available when the next session is started. In one embodiment, the session will restart the next time from the same point where it was left so that the gift recipient does not have to redo all the entries. Sometimes it is not necessary for a user to be logged into an account in order for the store to save the current session if it recognizes the client's computer (e.g., through the use of cookies or other means typically employed by online stores for similar purposes).

In one embodiment, the structure (i.e., online store facilities) already used in ordering the gift can be used to modify gifts. For example, each of shopping cart pages 400a and 400b in FIGS. 4a and 4b include a ‘Redeem gift’ button 416 that may be selected to open a USN entry text box (not shown) (these buttons would not be necessary if the page 1100 was used for redeeming). When the USN is entered, the gift item is added to the gift list. Gift prices may initially indicate ‘0.00’ or may reflect a difference if the gift was redeemed after the holding period and the price of the item changed. Each gift can be edited individually by clicking on it. This will open a shopping cart page similar to shopping cart page 400a. For the total gift, ‘Price’ will indicate the balance rather than the actual price, starting with ‘0.00’. Gift items can be deleted by checking the box in the ‘Delete’ column and selecting ‘Delete’ button 404, as before. Deleted items may still be displayed but can be grayed out and/or struck through. They may also be undeleted by clicking again on (i.e., toggling) ‘Delete’ button 404. After a gift item is deleted the corresponding amount is credited to the total balance as an available (positive) amount. To add the new items for which one or more of the initial gift items are exchanged, items can be added to the shopping cart from the online store catalog using ‘Continue shopping’ button 406. The total gift price box is updated as items are added or removed. In one embodiment, each gift can be modified individually. Other added items can remain in ‘Items in your cart’ list as regular purchases. Editing each gift individually can help keep track of exchanges done in relation to each gift.

After all the changes are done, the gift recipient may select a ‘Done editing gifts’ button 1112 if on ‘Redeem Gift’ page 1100, or ‘Continue to checkout’ button 414 if on a shopping cart page 400b, which will advance the gift redemption process to a block 308 in which delivery information of the recipient is entered. Just as the gift giver needed to input only familiar information, input of the delivery information is done directly by the person who best knows that information—the gift recipient. Mistakes that can inadvertently be made when entering an unfamiliar or rarely used address are therefore minimized compared to the existing methods where the gift giver has to enter this information. For a physical gift delivery, a street address is required. For electronic delivery and/or shipping confirmation, a preferred email address or, possibly, a telephone number are entered.

If the gift can be delivered by downloading from the store site or from a site in partnership with the store, the delivery information is specified by indicating the location where the download is to be placed or by just accepting the default location on the computer. Such gifts typically consist of movies, music, games, or other software applications. If exchanges were to be allowed before the gift items are downloaded, the gifting system of the present invention can be used. Thus, instead of just being sent a security code for direct downloading the gift article, the gift recipient can be presented with a redeemable gift certificate containing a USN as presented above. At redeeming, security codes for, say, one-time downloading of the gift items are accessible. However, if these items are to be exchanged, they can be replaced with other items offered by the merchant as described before. After all the exchanges are finalized and, if necessary, any balance own paid or payment in excess is deposited in a store account, new security codes for downloadable items will be available. The gift content can be updated with the new items and the security codes can be accessed using the same gift USN. Alternatively, the security codes can be sent, for example, by email or SMS in which case an email address or a phone number is required. When the gift items are downloaded, the gift recipient still needs to specify a delivery location or accept a default location on the computer media. If the exchanged gift contains a physical gift, street address for shipping would be required, as before. In all cases the gift recipient will be required to enter delivery information in one form or another. In some situations a full or partial physical address might be required for tax purposes.

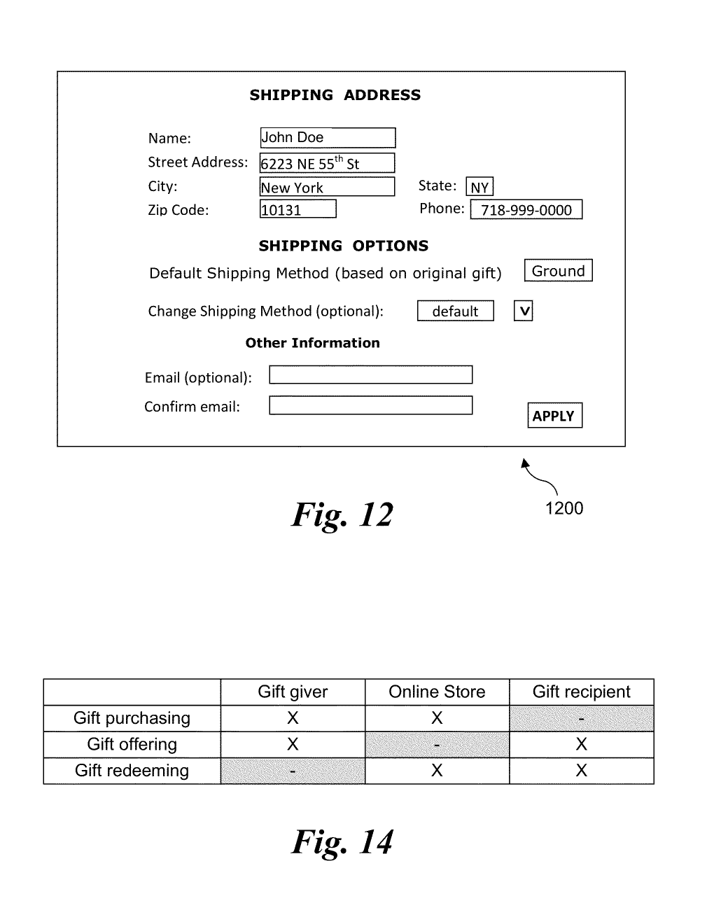

An exemplary delivery information page 1200 for entering conventional delivery information is shown in FIG. 12. The page is generally divided into a ‘Shipping Address’ section, a ‘Shipping Options’ section, and an ‘Other Information’ section. The ‘Shipping Address’ section depicts various text boxes for entering applicable shipping address information, such as name, street address, city, state, and Zip code. Of course, additional text boxes may be included, such as to enter a second address line. Other user interface controls for entering addresses and the like may be provided, such as a pull-down list to select a state. In addition to domestic addresses, in some embodiments foreign shipping addresses may also be supported with corresponding user interface objects. Delivery information page 1200 also shows a text box for entering a telephone number, which may generally be optional and can be used for SMS messages. The recipient may further include additional contact information in the ‘Other Information’ section, such as an e-mail address. In general, a gift recipient should be able to provide all this information quickly and reliably from memory.

The default shipping method is the one chosen initially by the gift giver or, in case of ambiguity due to multiple gifts, a method chosen by the store. For example, if more than one shipping method is specified in the gift certificates redeemed during the same session, the store may present a shipping method based on all the shipping methods input by the gift givers. For instance, if two delivery methods were 2-day delivery and one delivery method was ‘ground delivery’, the store may set the default to 2-day delivery for the cumulated order. If most of the shipping choices were ground delivery, the store may set ground delivery as the default delivery method. In case the initially method chosen by the gift giver is ‘store pick up’, the form contains a message like ‘please bring a photo ID and the USN to store when picking up your gift’. In order to document delivery, the identification documents will be used to record the identity of the redeemer at the store or to verify identity information already entered by the recipient before visiting the store. The form can also contain a check of the gift item availability at stores in the neighborhood in which case some approximate address like zip code or city need to be input.

The gift recipient also has the option to change the shipping method. For example, a store may offer its users free ground shipping for any purchase over a certain amount. Meanwhile, a recipient may desire to receive a gift item sooner, such as via overnight, 2-day, or 3-day delivery, or may want to pick up the gift in store. Applicable user interface objects (such as pull-down menus, lists, etc.) may be included in the ‘Change Shipping Method’ section to facilitate these changes. In addition to what is shown in delivery information page 1200, additional information may be included, such as additional handling costs.

After the shipping information is entered the store can accurately calculate Shipping and Handling costs and sales tax to determine the total balance, as depicted in a block 310 of FIG. 3. The shipping and handling costs might have changed because more gifts can be combined in just one shipment, weight and size of the exchanged items can be different, more personal purchase items are added during the gift redeeming session, change in shipping zone, or simply the gift recipient changes to a faster delivery method. For a regular gift that contains just one item, the shipping and handling cost are likely to remain unchanged.

In some instances, taxes may have to be collected on additional items, or for the difference in price relative to the initial price of the gift items. If a gift item was exchanged, taxes already collected for the initial gift item by the state of gift origin cannot be reimbursed. However, the price difference may be taxed by the state the gift is shipped to (gift recipient's state). If the balance is positive (the exchange is less than the gift item) the money will be deposited in a store account and can be used towards future purchases. The amount put in the store account is flagged as ‘gift item’ money and it will not be taxed again in the current state of shipping address.

In general, state and interstate rules for taxes on e-commerce transactions may apply. Shipping cost may need to be treated separately since they may have different taxation policies, depending on the state. For example, if the final shipping and handling costs are less than the shipping and handling paid from all the gifts combined, the difference may be applied towards purchases. In order to avoid double taxation, shipping and handling costs that have already been taxed in the state of gift origin is tagged as ‘gift’ money and is not taxed. To avoid having to pay minuscule amounts in difference due to different taxes for S&H, states can agree to adopt the S&H tax of the state of origin for online gifts and possibly attribute it to the state of destination. Already taxed money may be used first leaving the not-taxed amounts last. When a shipment address is not known, such as when the gift is delivered electronically, a residential address may be requested or the billing address can be used to calculate taxes on the difference amount. The latter generates an update of the total balance when the billing address is input.

The total price for delivery, as well as an updated of the total order balance including taxes are calculated during the operations for block 310. In one embodiment, these operations are initiated in response to the user selecting an ‘Apply’ button 1202 in delivery information page 1200.

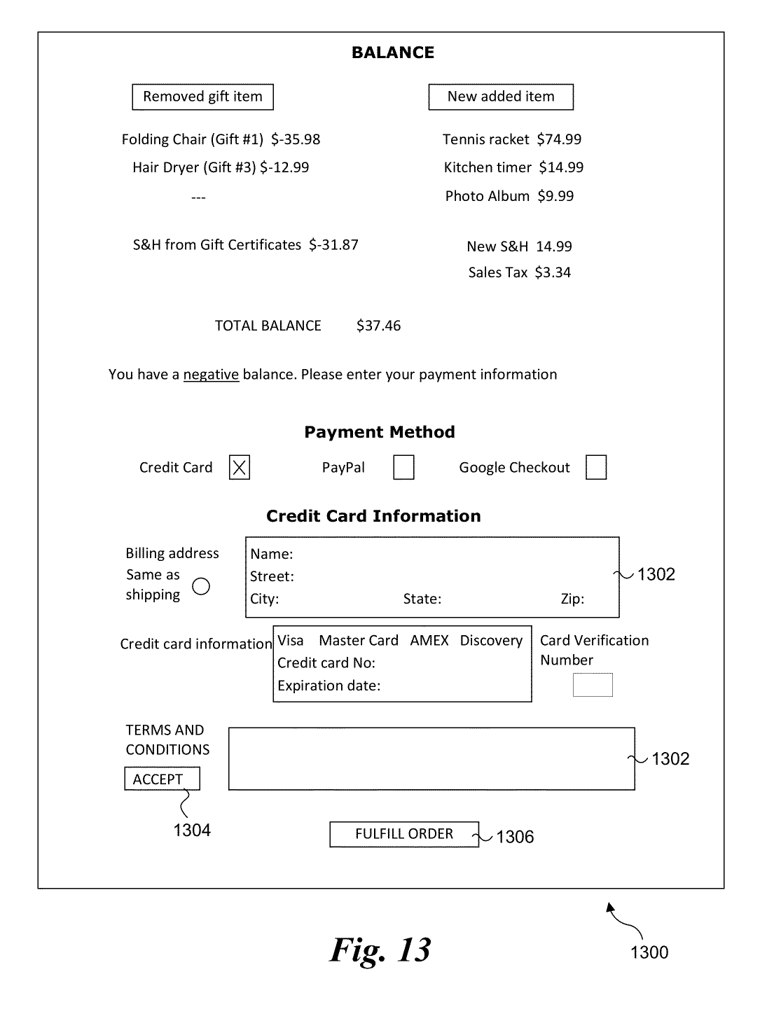

Any differences relative to the original gift are reported on a final balance page, as exemplified by a final balance page 1300 in FIG. 13. The store or the shopping cart provider may choose its own price reporting method. For example, in final balance page 1300 the first column shows the gift items that were removed, while the second column shows the items that were added. The cumulative shipping and handling from all gift certificates and the newly calculated shipping and handling are also provided, as illustrated. Typically, for one gift certificate with just one item, this will not change. On the next line, any difference in sale taxes after recalculation is shown (as ‘New S&H’).

Returning to the flowchart of FIG. 3, the next set of operations and logic are depicted in decision blocks 311, 313, and 315 and blocks 312, 314, and 316, with the logic flow as illustrated. As shown by decision block 311 and block 312, if the final balance is zero and if the gift is below a threshold value, the process proceeds directly to perform Terms & Conditions agreement and order fulfillment operations in a block 318. If the balance is positive, as determined in decision block 313, the remaining funds are put in a store account in block 314 for future purchases, which can be accessed through the regular store credit procedure. If a store account does not already exist, the gift recipient will be instructed on the steps to open a store account.

For gifts above a certain threshold value, the store can require gift recipient billing information like credit card number and billing address. The information is collected and checked for validity and credit availability against the order value but the credit card is not charged. If the customer already has payment information on file, such as if the gift recipient already has a store account and is logged in, collecting this information may not be necessary. Alternatively, for higher value items (e.g., watches, TVs etc.), a store representative may call the gift recipient to confirm identity.

If the balance is negative (money is owed), as determined in decision block 315, the gift recipient is asked to chose a method of payment and input billing information in block 316. The same form as the one used for ordering the gift may be used (e.g., payment form 700 of FIG. 7). If, for example, ‘Pay by credit card’ is chosen, corresponding credit card billing information is input. The payment information entered and the available credit is verified. The payment page may include a ‘Same as shipping’ selection to speed up input of billing address.

In one embodiment, a ‘Terms and Conditions’ agreement needs to be accepted before the order can be placed, with corresponding operations performed in block 318. An electronic copy of the agreement is made available for reading in a scrollable text box 1302, and the user indicates the acceptance of the agreement by selecting an ‘Accept’ button 1304. Certain exchange conditions, as well as policies reflecting that no refunds are given for gift items might be stipulated in the agreement. If acceptance is not acknowledged, a message will notify the user that he/she has first to accept the agreement before the order can be fulfilled.

To finalize the order, a ‘Fulfill order’ button 1306 is selected, as depicted in a block 320. If the session is interrupted before this button is selected, all or part of the information may need to be reentered to reach the fulfill order step, depending on the particular implementation of order balance page 1300.

If there is any outstanding balance, the card is pre-authorized when the order is submitted, as shown in a block 322. An email is sent to confirm the order and the items are readied for shipping. The card will be charged and the funds transferred to the store bank account when items are ready to be shipped, as depicted in a block 324. Since the store most likely has the gift giver's email address, a standard or customized thank you note can be sent to the gift giver informing him/her the gift has been redeemed.

In some embodiments, after-shipping exchanges may be permitted, as depicted in a block 326. For example, a store policy may allow for gift items or pre-shipment exchanged gift items to be exchanged after they are received. Refunds may be limited to the amount paid in addition to the gift price, since the gift amount may be non-refundable under some policies.

The details of the after-shipping exchange policy can be stipulated in the Terms & Conditions agreement as well as in the store's ‘Refunds and Exchanges’ policy. Typically, items may be exchanged within a certain amount of days after the items were redeemed. The rules for exchanges, including shipping and approved exchange codes can be similar to the exchange rules for regular purchases. In general, refunding and exchanges are a matter of store policy and can be adapted to suit each store's business practices.

Security Evaluation and Measures

As with any commercial transaction involving value items, fraud is possible. Since criminal investigation may be expensive and the results uncertain, preventing it from happening or reducing the risk is preferable. In one embodiment, the purchase transaction is facilitated via a client-server session over a secure connection (such as using an HTTPS connection). Delivery of the gift certificate can also be done over the same secure connection by loading a store web page containing the gift certificate. Sometimes, however, it might be desirable to receive the gift certificate by email as, for example, an Adobe PDF or Microsoft Word attachment that can then be printed for handing out in person or forwarding electronically to the gift recipient. Since regular email messages are generally not encoded, there is a theoretical possibility of email interception and fraudulent redeeming of the gift.

There are two instances when the gift certificate can travel by email and possibly be intercepted. First, when the store sends it to the gift giver and, second, if the gift recipient chooses to send it to the gift recipient by email. One way of providing security against email interception is through providing an additional private security code that will be used in conjunction with the basic USN to redeem the gift. Methods that deal with making the email delivery of the gift certificate more secure will be called secure email. The basic USN of the original certificate is in general a large digit number. The additional private security code can be, in general, a lesser digit string of characters, resembling the length of a typical password, for example. In this case, both the basic USN and the private security code are required for redeeming the gift. To insure security, the secondary code needs to be transmitted in such a way as to avoid interception. In a regular situation, for example, when the basic code is embedded in the gift certificate sent by email, the gift giver can opt to add a private code. One way to obtain the private code is to have the store generate and display it over the secure internet connection or transmit it as an SMS or an automatic telephone message. The gift giver can then jot the code down on a piece of paper and further transmit it to the gift recipient either in person on a hardcopy of the gift certificate, or through other methods such as telephone or SMS. Alternatively, the gift recipient can be asked to input a private security code of his choice which can be transmitted to the store during the secure gift purchasing session.

Yet another method of implementing a private code is for the gift giver to generate it so that it is relatively easy for the gift recipient but harder for another person to guess it. A question or a clue that would provide the private code can then accompany the gift certificate, such as: ‘When is your birthday?’, ‘How long have we known each other?’, ‘What state were you born in?’ The question does not have to be complicated, but specific enough to reduce the chances for somebody who is not the real gift recipient to be able to answer it correctly. This way there would be no need to transmit the private code. To keep things even simpler but still have some degree of protection, the private code (or password) can have a default value like, for example, the name of the online store. Also, the gift recipient's input may not even need to be exact but can only match the answer to a certain percentage level.

Another way of protecting against interception is by having the redeeming interface requiring the USN input by hand instead of clicking on a hyperlink. This makes automatic redeeming more difficult. Also, the USN can be written in ‘funny’ (CAPTCHA) characters to further discourage automatic access.

In general, security measures require additional inputs, thus complicating ordering, gift offering as well as gift redeeming processes. Using such methods should be carefully evaluated since the method itself, even without security enhancements, has inherent characteristics that would discourage fraud. Situations can arise when, for example, a stolen credit card is used to order the gift or the gift certificate is intercepted, stolen, or just found and the gift is fraudulently redeemed. According to the present method, delivery information must be provided by both the gift giver (to receive the gift certificate) and the gift recipient (to receive the gift). This provides traceability both ways and makes it possible to identify the wrongdoer. This makes is very unlikely for somebody to attempt to intercept and redeem a gift especially since they are, in general, limited value items with one-time use USNs that become useless once the gift is redeemed.

For more expensive gifts, the gift recipient may be required to input more detailed identifying information like credit card information (credit card number, expiration date, and billing address). In this case the credit card will not be charged but the information will be verified. In case the gift delivery is questioned, reliable information about the gift recipient is available.

In another way of providing enhanced security, the store can inform the gift giver that the gift has been redeemed and by whom. For example, the store could send a message like, ‘We wanted to let you know your gift order # . . . , has been redeemed.’ We will ship the gift to John Doe, at 6225 NE 53th St, New York, N.Y. 98003. You may confirm this information by going to ‘hyperlink_address’ and press ‘Release shipment’. Otherwise, press ‘Hold shipment’ and contact us. If no response is received, the gift will ship on Jul. 23, 2012.’ The store releases the shipment as soon as the gift giver confirms the gift recipient information or after the confirmation time expires. If there is any doubt about the recipient information, the gift giver can stop the shipment and contact the store or the gift recipient for clarification. He can then release the shipment or otherwise resolve the problem with the store.

The store and the shopping cart software provider or third party web site host are required to also safeguard sensitive information like the USNs from being accessed from within. Customer service, for example, may not have direct access to USNs for security reasons.

Lost Certificates

In case a paper gift certificate is lost, another copy can be printed or forwarded electronically or the gift can be canceled. Even if the gift certificate is non-nominal, if the certificate is lost and the person who finds it redeems it before the gift is canceled, a trace exists that can point to the person who found and redeemed the gift, which can help with recovering it. This is also a deterrent against redeeming lost gift certificates. A lost gift certificate is therefore more traceable than if the same physical article would be lost. The Terms and Conditions agreement may include proper wording so that, in such a situation, the store is not held responsible.

Exemplary Usage Scenarios

To better illustrate some of the advantages provided by embodiments of the invention, one can imagine the following common situation. A couple is preparing to leave for a birthday party and they are running pretty late. They have to leave in about thirty minutes and, because some misunderstanding of who was to buy it, the gift has not been purchased. The person celebrating his birthday is a good friend, and the couple has a pretty good idea what gift the friend would enjoy. However, there is no time to go to the store. The current alternative for online purchases is to buy the gift online and have it sent to his address. That typically means the friend has to be told about the gift and that it will arrive at his address during the following weeks. That, if the address they input is correct. The timing with the birthday occasion is compromised. Then, even though they had been at his/her place in the past, the exact street address is not known and it would take time to find it. Some stores might allow placing a gift order by only knowing the gift recipient email address, while they take it upon selves to contact the gift recipient and find out the shipping address. Still one would need to find the email address and enter it in the store shopping cart or a checkout page. People can be discouraged to order gifts online knowing that inputting gift recipient's shipping address or email wrong can compromise the gift.

It is also not known for sure if the recipient might want to exchange the gift for a different size, color, or another article offered by the same online store. It will be more difficult to do an exchange after the gift is received. An alternative would be purchase a monetary value gift card. But then, the gift givers want to show that they put some thought into the gift selection and would also not like it if the friend has to spend extra money on an object they want him to think is their gift.

This predicament may be conveniently addressed using aspects of one or more of the embodiments disclosed herein. The gift givers can quickly go online to an appropriate online store, chose the gift, fill in the information for facilitating the purchase aspect of the transaction which they know well since it is their own, such as billing address and email address, chose delivery methods for both the gift certificate and the gift item, all without having to check any records. The purchase can be completed by simply entering appropriate payment information, such as credit card number and expiration date or selecting a previously stored method of payment, and then selecting a ‘Place order’ button or the like to complete the order. Depending on the selected delivery method, an electronic form of the associated gift certificate may be downloaded and printed, and the couple can leave their house in minutes knowing they carry a gift the recipient would likely appreciate to the birthday party. A gift certificate purchaser is not left with any worries he or she might not have entered the correct information or that they did not pick the right size or color. The gift recipient will appreciate the good timing of the gift, the fact that the gift giver actually picked a specific item as opposed to a monetary value, and the convenience of easily being able to exchange it if, for any of reason, he or she decides to do so.

Gift Forwarding

The name of the gift recipient is not part of the gifting process, although in some embodiments it can be added to the gift certificate to customize it. From a store perspective, the gift as described above is non-nominal since for most common situations only the USN is needed to redeem it. This makes it easy for somebody who, for whatever reasons, wants to forward the gift to another person to do so by transmitting the redeeming information. This type of forwarding may be problematic for an embodiment in which the store informs the gift giver of the redeemer's name and asks for confirmation for delivery. In such a case, if not aware of what is going on, the gift giver may deny delivery out of concern of possible fraud. Enhanced security measures like a private code or answers to a personal question, if chosen, can further limit gift forwarding. Yet another problem with direct forwarding is that the more the gift certificate is held before forwarding, the shorter the holding period becomes and can eventually expire. If gift forwarding is desired, the system can facilitate that by removing barriers that can otherwise interfere with the forwarding process.

Partial Gifts and Group Gifts

In another embodiment, it is easy to adopt the techniques discussed above for making partial gifts and/or group gifts. When a group of people plan to pool their money to make one bigger gift, such as a racing bicycle, each gift giver can contribute a portion of the payment for the gift item, such as four people contributing 25% each. Similarly, each gift giver could pay a portion of the shipping and tax costs, or otherwise the total cost of the transaction may be split. In one embodiment, this may be facilitated by each of the gift givers purchasing a gift certificate representing their contribution of the total cost (such as 25% each in the foregoing example). When redeemed, the gift recipient enters all four gift certificates to cover the entire cost of the bike, including shipping. In case that, due to some misunderstanding or prior arrangements, one of the gift certificates is not received, the gift recipient can either pay for the difference himself or exchange the partial gift certificate(s) for a different article(s).

Other methods that rely on providing accurate recipient information might prove less reliable for making partial gifts, since consolidation of all the gifts into one will depend on having all the component gifts successfully going through the system. As in the previous example involving the bike, the store would have to contact the gift recipient four times, and each time they would have to confirm or communicate the shipping address. The store effort is substantially increased and the chances for the gift process to hang somewhere, possibly passed the holding period, are substantially increased as well.

Not-to-Exceed Value Gift Certificate

A situation can occur when, for example, a coffee drink is offered as a gift, for example, in Starbucks stores, and it is difficult to guess the exact beverage type and size the gift recipient would desire on a particular day. The existing solution to this is to send a gift card with a big enough value so that the gift recipient can chose a preferred treat. However, this value is usually more than the order, meaning the gift giver has to spend more than probably intended and the gift recipient needs to keep the gift card in order to use the remaining amount again later. A remedy of this situation is to offer a general gift (for example, ‘have a coffee on me today’) in which the gift recipient can chose different types and sizes of coffee drinks. The gift giver can specify a maximum amount for the order. The payment is then collected after the gift is redeemed, at which time the exact amount is known. This method works well, for example, when the gifts are made out of a prepaid account the gift giver has with the company since the company has already received payment. Similarly, if the shipping cost of a gift cannot be estimated, they can be charged on a not-to-exceed basis at the time the gift is redeemed.

Under embodiments disclosed herein, handing of gifts to recipients is taken out of the store's responsibility and put into the hands of the gift giver and gift recipient. Breaking the store gift giving process in two distinctive parts: gift purchasing and gift redeeming and acknowledging a third part, of conveying the gift certificate from the gift giver to the recipient, offers a superior gift giving method characterized by speed, flexibility, and reliability. The responsibilities for each part are given to the party that can handle them best: Gift purchase: Store & Gift giver; Gift Conveyance: Gift Giver & Gift Recipient; Gift redeeming: Gift recipient & Store. A matrix of responsibilities is shown in FIG. 14. An ‘X’ denotes involvement (or responsibility), while the gray cells denote non-involvement (or no responsibility). In previous online gift giving processes the store was also involved in the gift handing process, taking up responsibility for a process it does not have much control over. Having an uninterrupted responsibility from the beginning to the end of the gift process also meant that gift giving process was not effectively finished until both gift offering and gift redeeming were completed. This could delay receiving payment for the gift value. In the novel processes, gift offering is an independent process, outside of store jurisdiction. Just as it would normally happen, the gift offering takes place between the gift giver and the gift recipient. Interrupting the chain of responsibility makes the gift purchasing process a complete transaction unto itself. The store responsibility restarts again with gift redeeming.

Separating the processes has advantages for the gift giver and gift recipient as well. Not having the store involved in the gift offering ultimately means that the gift giver does not have to supply detailed and exact contact information for the gift recipient. The options for offering the gift are greatly amplified and timing can be accurately planned. This way, a more personal relation with the gift recipient is established.

Even though the store is not involved during the gift offering, there is still ample interaction between the store and the gift recipient during the gift redeeming process, a chance the store may truly appreciate for enlarging its customer base. In addition, convenient gift exchanges, if necessary, both before shipping and after shipping are easily implemented.

The teachings presented herein are generalized so that different aspects of the process can be seen and evaluated. For example, the users were enabled to order multiple gifts of more than one item each, as well as regular purchase items. Different delivery methods for different gifts can be chosen at gift purchasing, which can then be changed when the gift is redeemed. However, one of skill in the art will recognize that many variations may also be implemented. For example, a simpler, one-session-one-gift methods can be adopted. Thus, in order to simplify the process, just one gift of one or more items is bought during the gift purchasing session. During the redeeming session, if exchanges are to be made, the value of the removed items can go directly into a store account. The money from this account can then be used to buy replacement items during regular buying sessions. This is merely one example of how a system for facilitating gifting processes in accordance with the techniques taught herein may be modified.

### Click-and-Mortar Stores

Finally, the gift process described herein can be used, with only minor modifications, with online stores that also have a physical presence (also called click-and-mortar stores). For example, a gift certificate can similarly be purchased in person from a click-and-mortar retailer by asking the sales person to mark or otherwise identify a particular item as a gift to be picked up in store or for home delivery. The gift will be paid at the store and the gift certificate can be printed right away or sent by email or other means to the gift giver, or both. As before, recipient information is not required (but gift giver information for sending the gift certificate might be). The gift article is then put on hold for a number of days to allow time to be redeemed. The rest of the process is then carried out as described before which includes the gift giver transmitting the gift certificate to the gift recipient and the gift recipient being able to make changes to the gift items using form 1100 (FIG. 11), change the delivery method using form 1200 (FIG. 12), and pay for any additional expenses using form 1300 (FIG. 13).

A gift certificate can be redeemed either online or in person. If redeemed and picked up in person, the gift recipient provides the USN and sufficient personal information to document delivery which can be useful in case of a dispute or to send a gift receipt notification to the gift giver. The recipient can also fill out ID information online before coming to the store and then just have it verified based on a photo ID when taking delivery of the gift. In one embodiment, it is possible that the recipient is the same person as the gift giver.

In general, any combination of online and in store gift purchasing and redeeming can be imagined, such as purchasing the gift online and redeeming it in store, purchasing the gift in store and redeeming it online, purchasing the gift in store and redeeming it in store, or, as initially described, purchasing the gift online and redeeming it online, depending on personal preferences and the existence and accessibility of a physical store.

Exemplary Electronic Storefront Architecture

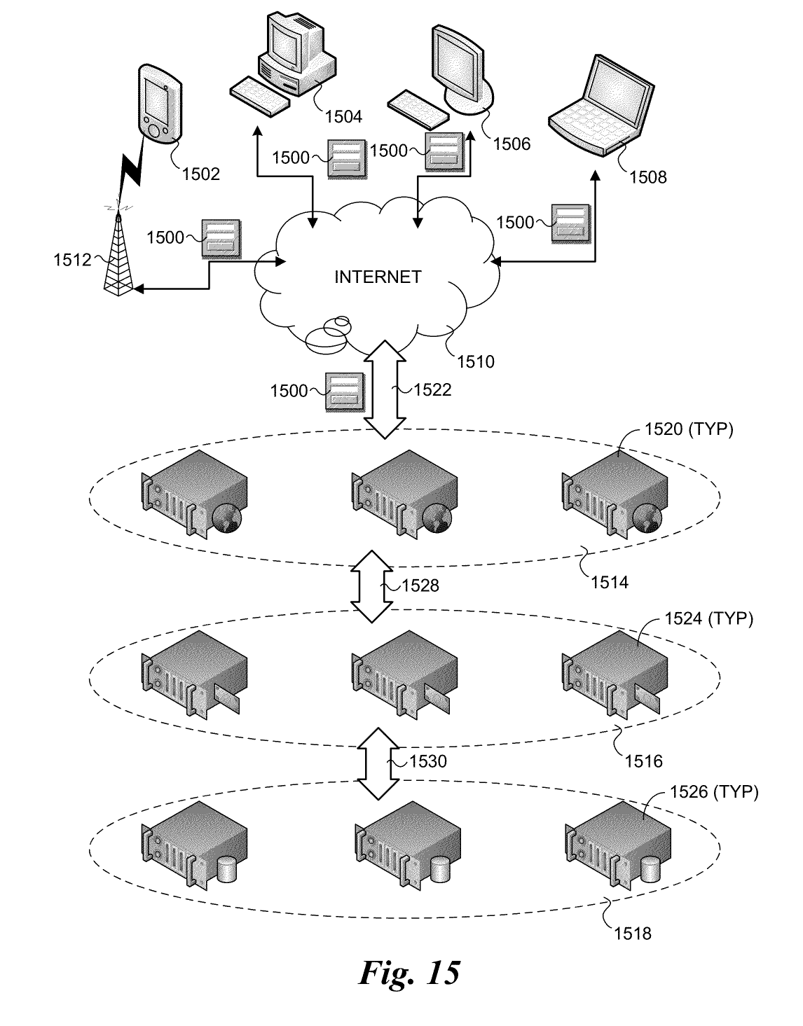

FIG. 15 shows a block-level illustration of an exemplary architecture for an electronic storefront that may be used to facilitate online transactions in accordance with teachings of the embodiments herein. The electronic storefront (also commonly referred to as an e-commerce web site) enables various clients to access web pages 1500 that are designed and implemented to facilitate corresponding transaction operations, such as catalog pages, shopping cart pages, checkout pages, etc. The clients illustrated in FIG. 15 include a mobile device 1502, desktop computers 1504 and 1506, and a laptop computer 1508. Mobile device 1502 is illustrative of various internet-enabled mobile devices, such as mobile phones, tablets, and iPod touches. Desktop computers 1504 and 1506 are illustrative of various types of home and work computers, including personal computers running Microsoft Windows operation systems, Apple Macintosh computers running Mac OS X operating systems, and computers running various forms of Linux operating systems. More generally, these computers represent any type of computing device typically referred to as a desktop computer, workstation, PC, etc. Laptop computer 1508 is illustrative of various portable computers, such as laptop computers, notebook computers, netbook computers, and ultrabook computers.

Each of mobile device 1502, desktop computers 1504 and 1506, and laptop computer 1508 are depicted as connected to Internet 1510, and employ an applicable web browser, such as desktop and mobile versions of Internet Explorer, Firefox, Chrome, Safari, etc. For simplicity, a direct connection is shown, but one skilled in the communications art will recognize that various network components and infrastructure are typically employed to facilitate Internet connections, such as network cards and interfaces, modems, switches, routers, ISP gateways, etc. Mobile clients may generally access the internet via an 802.11x (i.e., WiFi) connection, or via a mobile service provider network (i.e., cellular network) employing 2G, 3G or 4G connections based on GSM, UMTS, CDMA, CDMA2000, WCDMA, LTE, WIMAX, etc, using data services provided by the service provider (EDGE, GPRS, HSPA, HSPA+, etc.), including existing and future wireless technologies. For simplicity, the mobile service provider network infrastructure is collective illustrative by an antenna 1512.

As is well known, e-commerce web sites are typically implemented using an N-tier architecture such as the 3-tier architecture depicted in FIG. 15. Under this architecture, the tiers include a web server tier 1514, an application tier 1516, and a database tier 1518. Web server tier, also referred to as the front-end tier or front-end, includes one or more web servers 1520 (aka HTTP servers), which are connected to Internet 1510 via one or more broadband connections 1522. Web servers are configured to interact with clients using the HTTP protocol (also HTTPS), typically over TCP/IP connections. In general, Web servers 1520 may run applicable web server software, such as Apache or Microsoft IIS, as well as any other applicable web server software. Application tier 1516 includes one or more application servers 1524 running applicable application software. The software also includes interfaces to the other tiers commonly referred to as middleware, and the application tier is also commonly referred to as the middle tier. Database tier 1518, which is also referred to as the backend tier, includes one or more database servers 1526, which are configured to run applicable database server software, such as RDBMS software from Oracle (e.g., Oracle 11i), IBM DB2, Microsoft SQL server, Sybase, mySQL, etc. Database tier 1518 will include one or more RDBMS instances for storing data relating to electronic storefront operations, including data relating to customer database 110, catalog database 112, order database 114, and inventory database 116 of FIG. 1.

The various servers in the web server tier 1514, application tier 1516, and database tier 1518 are interconnected via applicable networks and protocols, as depicted by network interfaces 1528 and 1530. For example, the tiers may be connected via local area networks (LANs), or the architecture may employ distributed servers connected over wide area network (WANs). Communication between the tiers will typically employ common LAN or WAN protocols, and may employ applicable security measures. Communication between application server tier 1514 and database tier 1516 may use a client-server connection proprietary to a particular RDBMS host, or may employ an open standard such as ODBC or JDBC. In addition, the storage devices used for database tier 1518 may be implemented in another tier (storage tier) not shown. For example, various storage appliances and virtualized storage schemes available from various vendors, such Oracle (e.g. Exadata) EMS, and IBM may be implemented, as well as proprietary storage schemes employing storage arrays that are connected to the various database servers.

The electronic storefront may be implemented via custom software or commercially available bundled software running on the various tiers. For example, complete e-commerce electronic storefront software is available from IBM (e.g., various WebSphere Commerce products) and Oracle (e.g., Oracle iStore, Siebel e-commerce products, ATG Web Commerce). Optionally, an e-commerce storefront may be hosted by a third-party, such as via Amazon Web Services.

From the standpoint of an online store, operations for enabling gift purchases, redemption, and associated actions are facilitated by corresponding interactive web pages that are configured to present catalog offerings, receive customer input via various forms, and store data related to the transactions and other online store operations in one or more databases, such as, but not limited to the databases depicted in FIG. 1. The web pages are termed “interactive” because they support interaction with the user (customer) by accepting user input via the user's web browser client. Typically, applications in the application tier will implement the business logic for the online store, as well as generating web pages (or otherwise generating scripting or other code used to dynamically build web pages). Meanwhile, the web server front-end tier will be used for serving web pages and maintaining user sessions, and may be involved in the dynamic generation of web pages via execution of scripting used to build pages if these pages aren't generated by the application tier. The web server tier will also receive user input data (e.g., input form data) in response to various user inputs and user interface control selections, and forward the data to applicable business logic in the application tier. The application tier may then perform various processing on the data, including issuing data access commands to the backend database tier to store various data.

Generally, the various web pages described herein may be implemented via use HTML standards-based content (e.g., HTML 4.01, HTML 5, XHTML 1.1, CSS2.1 and CSS3) augmented with interactive content commonly referred under the umbrella term AJAX (Asynchronous JavaScript and XML) implemented through various scripting and interactive controls. Page content may also be dynamically generated on the server side via use of server-side scripting languages such as PHP or using Microsoft's Active Server Pages server-side scripting engine.

Exemplary Blade Server architecture

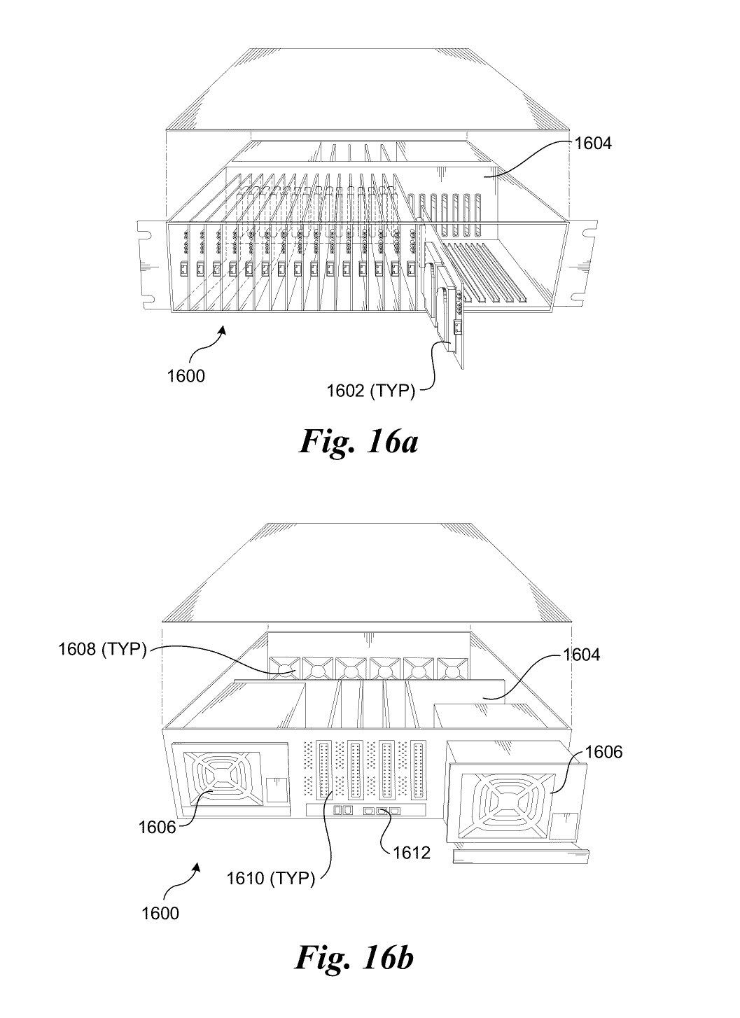

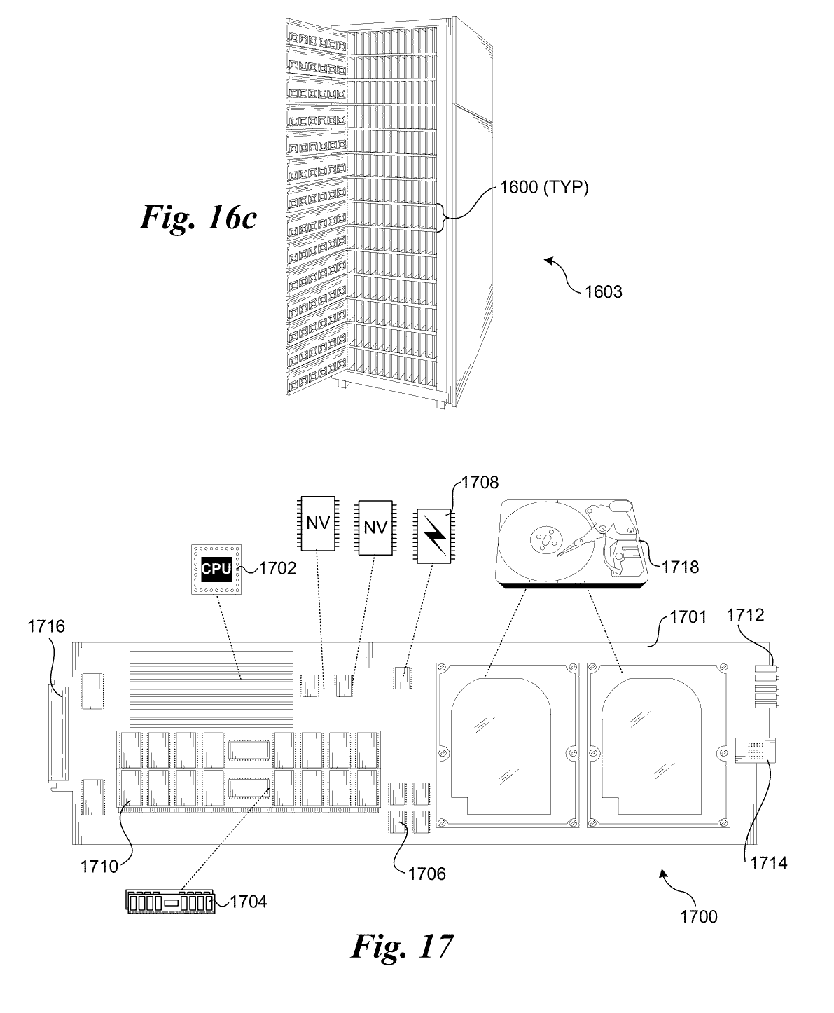

Typically, the servers used for the various tiers may be implemented as stand-alone servers, or arrayed server configurations such as rack-based servers or blade servers. As an overview, typical blade server components and systems are shown in FIGS. 16a-c, and 2. Under a typical configuration, a rack-mounted chassis 1600 is employed to provide power and communication functions for a plurality of server blades (i.e., blades) 1602, each of which occupies a corresponding slot. (It is noted that all slots in a chassis do not need to be occupied.) In turn, one or more chassis 1600 may be installed in a blade server rack 1603 shown in FIG. 16c. Each blade is coupled to an interface plane 1604 (i.e., a backplane or mid-plane) upon installation via one or more mating connectors. Typically, the interface plane will include a plurality of respective mating connectors that provide power and communication signals to the blades. Under current practices, many interface planes provide “hot-swapping” functionality—that is, blades can be added or removed (“hot-swapped”) on the fly, without taking the entire chassis down through appropriate power and data signal buffering.

A typical mid-plane interface plane configuration is shown in FIGS. 16a and 16b. The backside of interface plane 1604 is coupled to one or more power supplies 1606. Oftentimes, the power supplies are redundant and hot-swappable, being coupled to appropriate power planes and conditioning circuitry to enable continued operation in the event of a power supply failure. In an optional configuration, an array of power supplies may be used to supply power to an entire rack of blades, wherein there is not a one-to-one power supply-to-chassis correspondence. A plurality of cooling fans 1608 are employed to draw air through the chassis to cool the server blades.

An important feature required of all blade servers is the ability to communicate externally with other IT infrastructure. This is typically facilitated via one or more network connect cards 1610, each of which is coupled to interface plane 1604. Generally, a network connect card may include a physical interface comprising a plurality of network port connections (e.g., RJ-45 ports), or may comprise a high-density connector designed to directly connect to a network device, such as a network switch, hub, or router.

Blade servers usually provide some type of management interface for managing operations of the individual blades. This may generally be facilitated by a built-in network or communication channel or channels. For example, one or more buses for facilitating a “private” or “management” network and appropriate switching may be built into the interface plane, or a private network may be implemented through closely-coupled network cabling and a network. Optionally, the switching and other management functionality may be provided by a management switch card 1612 that is coupled to the backside or frontside of the interface plane. As yet another option, a management or configuration server may be employed to manage blade activities, wherein communications are handled via standard computer networking infrastructure, for example, Ethernet.

With reference to FIG. 17, further details of an exemplary blade 1700 are shown. As discussed above, each blade comprises a separate computing platform that is configured to perform server-type functions, i.e., is a “server on a card.” Accordingly, each blade includes components common to conventional servers, including a main printed circuit board (main board) 1701 providing internal wiring (i.e., buses) for coupling appropriate integrated circuits (ICs) and other components mounted to the board. These components include one or more processors 1702 coupled to system memory 1704 (e.g., DDR (double data rate) RAM), cache memory 1706 (e.g., SDRAM), and a firmware storage device 1708 (e.g., flash memory). A “public” NIC (network interface controller) chip 1710 is provided for supporting conventional network communication functions, such as to support communication between a blade and external network infrastructure. Other illustrated components include status LED (light-emitting diodes) 1712, an RJ-45 console port 1714, and an interface plane connector 1716. Additional components include various passive components (i.e., resistors, capacitors), power conditioning components, and peripheral device connectors.

Generally, each blade 1700 may also provide on-board storage. This is typically facilitated via one or more built-in disk controllers and corresponding connectors to which one or more disk drives 1718 are coupled. For example, typical disk controllers include Ultra ATA controllers, SCSI controllers, and the like. As an option, the disk drives may be housed separate from the blades in the same or a separate rack, such as might be the case when a network-attached storage (NAS) appliance is employed for storing large volumes of data or one of the virtualized storage schemes discussed above.

As discussed above, various aspects of the embodiments herein are facilitated by corresponding software components and applications, such as software running on the server tiers and web browser software running on the clients. Thus, embodiments of this invention may be used as or to support a software program, software modules, and/or distributed software executed upon some form of processing core (such as the CPU of a computer, one or more cores of a multi-core processor), a virtual machine running on a processor or core or otherwise implemented or realized upon or within a machine-readable medium. A machine-readable medium includes any mechanism for storing or transmitting information in a form readable by a machine (e.g., a computer). For example, a machine-readable medium may include a read only memory (ROM); a random access memory (RAM); a magnetic disk storage media; an optical storage media; and a flash memory device, etc.

In general, the various operations of the embodiment herein may be facilitated by corresponding apparatus (e.g., client devices and servers) via execution of applicable software (web browser software on clients and server-side software including web server software, application software, and database software). On the server side, in addition to distributed software executing on multiple physically-separate machines, all or a portion of the various software applications and modules may be implemented on a single machine (e.g., a smaller e-commerce site may employ software corresponding to various tiers executing on virtual machines running on a server employing one or more multi-core processors or directly executing on such processors).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method, comprising:
during a first session comprising a gift certificate purchase process,
serving a first plurality of interactive Web pages configured to,
enable a gift giver to select one or more gift items to be associated with a gift certificate via which the one or more gift items may be redeemed; and
enable the gift giver to purchase the gift certificate via an online transaction;
generating gift certificate information associated with the gift certificate purchased via the online transaction, the gift certificate information including a redemption code;
storing information associating the gift certificate with the one or more gift items and the redemption code; and
facilitating delivery of the gift certificate information to the gift giver via at least one of electronic delivery or physical delivery; and
during a second session comprising a gift certificate redemption process,
serving at least one Web page configured to,
enable a gift recipient to redeem the gift certificate via entry of the redemption code; and
enable the gift recipient to enter delivery information to facilitate receipt of one or more items associated with the redemption process.

2. The method of claim 1, wherein the one or more items associated with the gift redemption process comprise the one or more items associated with the gift certificate.

3. The method of claim 1, further comprising serving one or more interactive Web pages during the redemption process to enable the gift recipient to replace one or more gift items associated with the gift certificate with one or more different items selected by the gift recipient.

4. The method of claim 1, wherein at least one of the one or more gift items comprises electronic content, and during the redemption process the gift recipient is enabled to specify delivery information identifying a means via which the electronic content is to be delivered.

5. The method of claim 1, wherein the first plurality of interactive Web pages enable each of multiple gift givers to purchase a gift certificate corresponding to a partial gift item, and wherein a gift recipient may enter redemption codes from multiple gift certificates received from the multiple gift givers to redeem the gift item.

6. The method of claim 1, wherein the first plurality of interactive Web pages further enable the gift giver user to enter delivery information corresponding to delivery of the one or more gift items that does not require a full shipping address and enable a calculated delivery cost to be included in a purchase price of the gift certificate such that when the gift certificate is redeemed the delivery cost is prepaid.

7. The method of claim 1, wherein facilitating delivery of the gift certificate comprises creating an electronic version of the gift certificate and one of sending the electronic version of the gift certificate to the gift giver or enabling the gift giver to access the electronic version of the gift certificate.

8. The method of claim 1, wherein facilitating delivery of the gift certificate comprises serving a Web page including either an electronic replication of the gift certificate contained in the Web page, or a PDF document corresponding to the gift certificate that may be viewed and printed via a Web browser client using a PDF reader browser plug-in.

9. The method of claim 1, wherein the plurality of interactive Web pages includes a shopping cart page having user input objects that may be selected by a user to enable an item listed on the shopping cart page to be identified as a gift to be associated with a gift certificate.

10. The method of claim 1, wherein the plurality of interactive Web pages includes a gift certificate customization form containing one or more text boxes via which the gift giver is enabled to enter textual input to be included in the gift certificate.

11. The method of claim 1, further comprising implementing one or more of the following security measures:
a) employing a second private code to facilitate redemption of the gift certificate; and
b) requiring the gift recipient to correctly or partially correctly answer a question formulated by the gift giver or selected from a list of questions by the gift giver.

12. The method of claim 1, further comprising sending the gift giver a notification after the gift has been redeemed comprising information regarding an identity of the gift redeemer.

13. The method of claim 1, further comprising providing a time interval after the gift certificate redemption process during which the gift giver is enabled to stop delivery of the one or more items associated with the redemption process.

14. The method of claim 1, wherein the redemption process enables that one or more items associated with the redemption process to be forwarded to another gift recipient as whole or as part of a gift certificate redeemable by the other gift recipient.

15. The method of claim 1, further comprising automatically charging a credit card account at least part of the gift certificate value after the redemption process is completed up to a maximum amount specified by the gift giver.

16. The method of claim 1, further comprising:
serving a web page to enable the gift recipient to select to pick up one or more items associated with the redemption process at a selected store location;
automatically searching inventory at the selected store location to verify the one or more items are in stock; and
if any item is not in stock, automatically arranging for delivery of the item to the selected store location.

17. Non-transient machine readable media having a plurality of software modules comprising instructions tangibly stored thereon configured to be executed on at least one server associated with an online store to facilitate processes associated with gifting by performing operations comprising:
during a first session comprising a gift certificate purchase process,
generating a first plurality of interactive Web pages configured to receive input via a Web browser client of a gift giver user of the online store to,
enable the gift giver to select items offered by the online store as one or more gift items to be associated with a gift certificate via which the one or more gift items may be redeemed; and
enable the gift giver to purchase the gift certificate via an online transaction;
generating a gift certificate associated with the gift certificate purchased via the online transaction, the gift certificate including a redemption code;
storing information associating the gift certificate with the one or more gift items and the redemption code; and
facilitating delivery of the gift certificate to the gift giver via at least one of electronic delivery or physical delivery of the gift certificate; and
during a second online session comprising a gift certificate redemption process,
generating one or more interactive Web pages configured to,
enable a gift recipient to redeem the gift certificate via entry of the redemption code in a Web page served to a Web browser client used by the gift recipient; and
enable the gift recipient to enter delivery information to facilitate delivery of one or more items associated with the gift redemption process to the gift recipient.

18. The non-transient machine readable media of claim 17, wherein the one or more items associated with the gift redemption process comprise the one or more items associated with the gift certificate.

19. The non-transient machine readable media of claim 17, wherein execution of the instructions perform further operations comprising serving one or more interactive Web pages during the redemption process to enable the gift recipient to replace one or more gift items associated with the gift certificate with one or more different items selected by the gift recipient.

20. The non-transient machine readable media of claim 17, wherein at least one of the one or more gift items comprises electronic content, and during the redemption process the gift recipient is enabled to specify delivery information identifying a means via which the electronic content is to be delivered.

21. The non-transient machine readable media of claim 17, wherein the first plurality of interactive Web pages enable each of multiple gift givers to purchase a gift certificate corresponding to a partial gift item, and wherein a gift recipient may enter redemption codes from multiple gift certificates received from the multiple gift givers to redeem the gift item.

22. The non-transient machine readable media of claim 17, wherein the first plurality of interactive Web pages further enable the gift giver user to enter delivery information corresponding to delivery of the one or more gift items that does not require a full shipping address and enable a calculated delivery cost to be included in a purchase price of the gift certificate such that when the gift certificate is redeemed the delivery cost is prepaid.

23. The non-transient machine readable media of claim 17, wherein facilitating delivery of the gift certificate comprises serving a Web page including either an electronic replication of the gift certificate contained in the Web page, or a PDF document corresponding to the gift certificate that may be viewed and printed via a Web browser client using a PDF reader browser plug-in.

24. The non-transient machine readable media of claim 17, wherein the plurality of interactive Web pages includes a shopping cart page having user input objects that may be selected by a user to enable an item listed on the shopping cart page to be identified as a gift to be associated with a gift certificate.

25. The non-transient machine readable media of claim 17, wherein execution of the instructions perform further operations comprising implementing one or more of the following security measures:
a) employing a second private code to facilitate redemption of the gift certificate; and
b) requiring the gift recipient to correctly or partially correctly answer a question formulated by the gift giver or selected from a list of questions by the gift giver.

26. The non-transient machine readable media of claim 17, wherein execution of the instructions perform further operations comprising:
sending the gift giver a notification after the gift certificate has been redeemed comprising information regarding an identity of the gift redeemer; and,
setting a time interval after the notification is sent during which the gift giver is enabled to stop delivery of the one or more items associated with the redemption process.

27. The non-transient machine readable media of claim 17, wherein execution of the instructions perform further operations comprising automatically charging a credit card account at least part of the gift certificate value after the redemption process is completed up to a maximum amount specified by the gift giver.
